(19) United States
(12) Patent Application Publication
(10) Pub. No.: US 2022/0038855 A1
(43) Pub. Date: Feb. 3, 2022

(54) DETERMINATION OF PRESENCE IN GEOGRAPHIC REGION

(71) Applicant: Qualcomm INCORPORATED, San Diego, CA (US)

(72) Inventor: William WHYTE, Belmont, MA (US)

(21) Appl. No.: 16/941,646

(22) Filed: Jul. 29, 2020

(51) Int. Cl. H04W 4/029; H04W 4/021; H04W 4/024; H04W 4/02

(52) U.S. Cl. CPC H04W 4/029; H04W 4/021; H04W 4/46; H04W 4/023; H04W 4/024

(57) ABSTRACT

A method of providing positioning information includes: receiving, at a first UE from a second UE, a request that includes a location and a geographic region of interest; and sending, from the first UE to the second UE: at least one first one-way tree portion, of a one-way tree, comprising at least one first one-way sub-value corresponding to at least one first sub-area of a map area and that includes the location, the one-way tree corresponding to the map area; and at least one second one-way tree portion of the one-way tree comprising at least one second one-way sub-value and corresponding to at least one second sub-area; the at least one first one-way sub-value and the at least one second one-way sub-value together comprising a complete data set for determining a root value of the one-way tree and correspond, in combination, to the map area.

### BACKGROUND

The connected-vehicle radio-frequency environment is a spectrum-limited, bandwidth-limited resource. For example, the available spectrum may be about 20 MHz at just under 6 GHz. This spectrum may be increasingly used as more radio-frequency-based connected-vehicle (e.g., vehicle to everything (V2X)) transactions occur. This spectrum, or one or more other spectrums, may have similar limitations and may be used for vehicle applications or other applications, e.g., pedestrian-to-everything (P2X) applications. Also, some radio protocols do not provide reliable unicast performance. Systems, such as vehicle tolling systems, relying on V2X transactions may miss vehicles that traverse a transaction enforcement region. For example, when a vehicle enters a transaction enforcement region and transmits a message to a roadside equipment (RSE) (also called a roadside unit (RSU)), the RSE may not receive or be able to process the message, and thus may miss a desired transaction (e.g., collection of a fee). A failed transaction may have one or more consequences such as lost revenue for the concessionaire and/or increased cost of enforcement to obtain a fee by other means such as visual inspection (possibly by a person) to identify the vehicle and further efforts to obtain payment from an account associated with the vehicle. Various factors may affect the ability to effect a transaction with a vehicle that passes through a transaction enforcement region. For example, topology of the transaction enforcement region, changing traffic conditions, vehicle speeds, and/or radio frequency (RF) bandwidth congestion from other (vehicle) transmissions may affect the ability of a system to obtain appropriate information for, if not complete, a transaction while a vehicle passes through the transaction enforcement region.

Vehicles may transmit multiple transaction-inducing messages to attempt to overcome poor unicast performance, but this may come at cost. The multiple messages may increase the probability of the RSE detecting and processing one of the messages. The multiple transmissions, however, especially with many other vehicles in the vicinity, with many or all of them making multiple transmissions, may adversely affect the local radio environment (e.g., increased channel congestion and/or interference) and degrade the ability to receive the transaction-inducing messages and/or other types of messages such as vehicle safety messages.

### SUMMARY

An example method of providing positioning information includes: wirelessly receiving, at a first user equipment (UE) from a second UE, a map request that includes a location and a geographic region of interest; and wirelessly sending, from the first UE to the second UE: at least one first one-way tree portion, of a one-way tree, comprising at least one first one-way sub-value of the one-way tree and corresponding to at least one first sub-area that spans less than a map area and that includes the location, the one-way tree corresponding to the map area; and at least one second one-way tree portion of the one-way tree comprising at least one second one-way sub-value of the one-way tree and corresponding to at least one second sub-area of the map area; where the at least one first one-way sub-value and the at least one second one-way sub-value together comprise a complete data set for determining a root value of the one-way tree and correspond, in combination, to the map area; and where the map area includes the geographic region of interest.

Implementations of such a method may include one or more of the following features. The at least one first one-way tree portion consists of a single first one-way tree portion that corresponds to a single first sub-area that includes the location, the single first one-way tree portion including an indication of whether the single first sub-area is within the geographic region of interest. The at least one second sub-area corresponds to all of the map area other than the at least one first sub-area. The method includes wirelessly sending, from the first UE to the second UE, the root value, of the one-way tree, digitally signed with a digital signature. The at least one first sub-area includes a path from the location to an edge of the map area. For each crossing of a border of the geographic region of interest by the path, a corresponding one of the at least one first one-way tree portion is of a highest resolution of the one-way tree. Each of the at least one first one-way tree portion that indicates that the respective first sub-area lacks any portion of the border of the geographic region of interest is of a lowest resolution possible, of the one-way tree, while the respective first sub-area includes a corresponding portion of the path and lacks any portion of the border of the geographic region of interest. The at least one second one-way tree portion consists of a minimum number of one or more one-way tree portions in addition to the at least one first one-way tree portion in order to enable determination of the root value of the one-way tree.

An example of a user equipment (UE) includes: a transceiver configured to wirelessly receive and transmit signals; a memory storing a map; and a processor, communicatively coupled to the transceiver and the memory, configured to respond to receiving, via the transceiver, a map request that includes a location and a geographic region of interest by determining and sending, via the transceiver: at least one first one-way tree portion, of a one-way tree, comprising at least one first one-way sub-value of the one-way tree and corresponding to at least one first sub-area that spans less than a map area and that includes the location, the one-way tree corresponding to the map area; and at least one second one-way tree portion of the one-way tree comprising at least one second one-way sub-value of the one-way tree and corresponding to at least one second sub-area of the map area; where the at least one first one-way sub-value and the at least one second one-way sub-value together comprise a complete data set for determining a root value of the one-way tree and correspond, in combination, to the map area; and where the map area includes the geographic region of interest.

Implementations of such a UE may include one or more of the following features. The at least one first one-way tree portion consists of a single first one-way tree portion that corresponds to a single first sub-area that includes the location, the single first one-way tree portion including an indication of whether the single first sub-area is within the geographic region of interest. The at least one second sub-area corresponds to the all of map area other than the at least one first sub-area. The processor is configured to send, via the transceiver, the root value, of the one-way tree, digitally signed with a digital signature. The at least one first sub-area includes a path from the location to an edge of the map area. For each crossing of a border of the geographic region of interest by the path, a corresponding one of the at least one first one-way tree portion is of a highest resolution of the one-way tree. Each of the at least one first one-way tree portion that indicates that the respective first sub-area lacks any portion of the border of the geographic region of interest is of a lowest resolution possible, of the one-way tree, while the respective first sub-area includes a corresponding portion of the path and lacks any portion of the border of the geographic region of interest. The at least one second one-way tree portion consists of a minimum number of one or more one-way tree portions in addition to the at least one first one-way tree portion in order to enable determination of the root value of the one-way tree.

An example of a first user equipment (UE) includes: first means for wirelessly receiving, from a second UE, a map request that includes a location and a geographic region of interest; second means for determining and wirelessly sending, to the second UE: at least one first one-way tree portion, of a one-way tree, comprising at least one first one-way sub-value of the one-way tree and corresponding to at least one first sub-area that spans less than a map area and that includes the location, the one-way tree corresponding to the map area; and at least one second one-way tree portion of the one-way tree comprising at least one second one-way sub-value of the one-way tree and corresponding to at least one second sub-area of the map area; where the at least one first one-way sub-value and the at least one second one-way sub-value together comprise a complete data set for determining a root value of the one-way tree and correspond, in combination, to the map area; and where the map area includes the geographic region of interest.

Implementations of such a UE may include one or more of the following features. The at least one first one-way tree portion consists of a single first one-way tree portion that corresponds to a single first sub-area that includes the location, the single first one-way tree portion including an indication of whether the single first sub-area is within the geographic region of interest. The at least one second sub-area corresponds to all of the map area other than the at least one first sub-area. The second means are further for determining and wirelessly sending, to the second UE, the root value, of the one-way tree, digitally signed with a digital signature. The at least one first sub-area includes a path from the location to an edge of the map area. For each crossing of a border of the geographic region of interest by the path, a corresponding one of the at least one first one-way tree portion is of a highest resolution of the one-way tree. Each of the at least one first one-way tree portion that indicates that the respective first sub-area lacks any portion of the border of the geographic region of interest is of a lowest resolution possible, of the one-way tree, while the respective first sub-area includes a corresponding portion of the path and lacks any portion of the border of the geographic region of interest. The at least one second one-way tree portion consists of a minimum number of one or more one-way tree portions in addition to the at least one first one-way tree portion in order to enable determination of the root value of the one-way tree.

An example non-transitory, processor-readable storage medium includes processor-readable instructions configured to cause a processor, in order to provide positioning information, to: respond to receiving, via a transceiver, a map request that includes a location and a geographic region of interest by determining and sending, via the transceiver: at least one first one-way tree portion, of a one-way tree, comprising at least one first one-way sub-value of the one-way tree and corresponding to at least one first sub-area that spans less than a map area and that includes the location, the one-way tree corresponding to the map area; and at least one second one-way tree portion of the one-way tree comprising at least one second one-way sub-value of the one-way tree and corresponding to at least one second sub-area of the map area; wherein the at least one first one-way sub-value and the at least one second one-way sub-value together comprise a complete data set for determining a root value of the one-way tree and correspond, in combination, to the map area; and wherein the map area includes the geographic region of interest.

Implementations of such a storage medium may include one or more of the following features. The at least one first one-way tree portion consists of a single first one-way tree portion that corresponds to a single first sub-area that includes the location, the single first one-way tree portion including an indication of whether the single first sub-area is within the geographic region of interest. The at least one second sub-area corresponds to the all of map area other than the at least one first sub-area. The instructions are configured to cause the processor to send, via the transceiver, the root value, of the one-way tree, digitally signed with a digital signature. The at least one first sub-area includes a path from the location to an edge of the map area. For each crossing of a border of the geographic region of interest by the path, a corresponding one of the at least one first one-way tree portion is of a highest resolution of the one-way tree. Each of the at least one first one-way tree portion that indicates that the respective first sub-area lacks any portion of the border of the geographic region of interest is of a lowest resolution possible, of the one-way tree, while the respective first sub-area includes a corresponding portion of the path and lacks any portion of the border of the geographic region of interest. The at least one second one-way tree portion consists of a minimum number of one or more one-way tree portions in addition to the at least one first one-way tree portion in order to enable determination of the root value of the one-way tree.

An example method of producing an authenticated multi-resolution map includes: assigning a plurality of node values to a respective plurality of nodes of a map comprising map components that comprise segments and the plurality of nodes, the map having a map area that includes a geographic region of interest, the map components providing a plurality of levels of resolution of the map area, the segments corresponding to respective sub-areas of the map area and having respective segment values indicative of physical relationships of the respective sub-areas to the geographic region of interest, wherein the plurality of node values are assigned such that a respective node value of each particular node of the plurality of nodes is a result of a one-way function of two or more map component values of respective ones of the map components of a next-higher resolution level relative to the particular node, wherein the segment values and the plurality of node values form a one-way tree with the node value of a lowest-resolution level of the plurality of levels of resolution of the map area being a root value of the one-way tree; and digitally signing the root value of the one-way tree to produce a digitally-signed root value, wherein the authenticated multi-resolution map comprises the segment values, the plurality of node values, and the digitally-signed root value.

Implementations of such a method may include one or more of the following features. The method includes: dividing the map area into the map components; and assigning the segment values to the segments. The map area is divided such that a combination of all of the segments span all of the map area. A non-zero segment value indicates that the respective sub-area includes a portion of a border of the geographic region of interest. The map area is divided in accordance with a protocol of segment size and segment arrangement such that the respective sub-area of each segment having a respective segment value of zero is as large as possible in accordance with the protocol of segment size and segment arrangement without the respective sub-area including any portion of the border of the geographic region of interest. Each of the segment values indicates whether the respective sub-area is inside the geographic region of interest or outside of the geographic region of interest. The map area is divided in accordance with a protocol of segment size and segment arrangement such that the respective sub-area of each segment is as large as possible in accordance with the protocol of segment size and segment arrangement while being either completely inside the geographic region of interest or completely outside of the geographic region of interest.

An example server for producing an authenticated multi-resolution map includes: a memory; a processor, communicatively coupled to the memory, configured to: assign a plurality of node values to a respective plurality of nodes of a map comprising map components that comprise segments and the plurality of nodes, the map having a map area that includes a geographic region of interest, the map components providing a plurality of levels of resolution of the map area, the segments corresponding to respective sub-areas and having respective segment values indicative of physical relationships of the respective sub-areas of the map area to the geographic region of interest, wherein the processor is configured to assign the plurality of node values such that a respective node value of each particular node of the plurality of nodes is a result of a one-way function of two or more map component values of respective ones of the map components of a next-higher resolution level relative to the particular node, wherein the segment values and the plurality of node values form a one-way tree with the node value of a lowest-resolution level of the plurality of levels of resolution of the map area being a root value of the one-way tree; and digitally sign the root value of the one-way tree to produce a digitally-signed root value, wherein the authenticated multi-resolution map comprises the segment values, the plurality of node values, and the digitally-signed root value.

Implementations of such a server may include one or more of the following features. The processor is configured to: divide the map area into the map components; and assign the segment values to the segments. The processor is configured to divide the map area such that a combination of all of the segments span all of the map area. The processor is configured to assign a non-zero segment value to indicate that the respective sub-area includes a portion of a border of the geographic region of interest. The processor is configured to divide the map area in accordance with a protocol of segment size and segment arrangement such that the respective sub-area of each segment having a respective segment value of zero is as large as possible in accordance with the protocol of segment size and segment arrangement without the respective sub-area including any portion of the border of the geographic region of interest. The processor is configured to assign the segment values to indicate whether the respective sub-area is inside the geographic region of interest or outside of the geographic region of interest. The processor is configured to divide the map area in accordance with a protocol of segment size and segment arrangement such that the respective sub-area of each segment is as large as possible in accordance with the protocol of segment size and segment arrangement while being either completely inside the geographic region of interest or completely outside of the geographic region of interest.

Another example server for producing an authenticated multi-resolution map includes: means for assigning a plurality of node values to a respective plurality of nodes of a map comprising map components that comprise segments and the plurality of nodes, the map having a map area that includes a geographic region of interest, the map components providing a plurality of levels of resolution of the map area, the segments corresponding to respective sub-areas and having respective segment values indicative of physical relationships of the respective sub-areas of the map area to the geographic region of interest, wherein the means for assigning the plurality of node values are for assigning the plurality of node values such that a respective node value of each particular node of the plurality of nodes is a result of a one-way function of two or more map component values of respective ones of the map components of a next-higher resolution level relative to the particular node, wherein the segment values and the plurality of node values form a one-way tree with the node value of a lowest-resolution level of the plurality of levels of resolution of the map area being a root value of the one-way tree; and means for digitally signing the root value of the one-way tree to produce a digitally-signed root value, wherein the authenticated multi-resolution map comprises the segment values, the plurality of node values, and the digitally-signed root value.

Implementations of such a server may include one or more of the following features. The server includes: dividing means for dividing the map area into the map components; and means for assigning the segment values to the segments. The dividing means are for dividing the map area such that a combination of all of the segments span all of the map area. A non-zero segment value indicates that the respective sub-area includes a portion of a border of the geographic region of interest. The dividing means are for dividing the map area in accordance with a protocol of segment size and segment arrangement such that the respective sub-area of each segment having a respective segment value of zero is as large as possible in accordance with the protocol of segment size and segment arrangement without the respective sub-area including any portion of the border of the geographic region of interest. Each of the segment values indicates whether the respective sub-area is inside the geographic region of interest or outside of the geographic region of interest. The dividing means are for dividing the map area in accordance with a protocol of segment size and segment arrangement such that the respective sub-area of each segment is as large as possible in accordance with the protocol of segment size and segment arrangement while being either completely inside the geographic region of interest or completely outside of the geographic region of interest.

An example non-transitory, processor-readable storage medium includes processor-readable instructions configured to cause a processor, in order to produce an authenticated multi-resolution map, to: assign a plurality of node values to a respective plurality of nodes of a map comprising map components that comprise segments and the plurality of nodes, the map having a map area that includes a geographic region of interest, the map components providing a plurality of levels of resolution of the map area, the segments corresponding to respective sub-areas of the map area and having respective segment values indicative of physical relationships of the respective sub-areas to the geographic region of interest, wherein instructions are configured to cause the processor to assign the plurality of node values such that a respective node value of each particular node of the plurality of nodes is a result of a one-way function of two or more map component values of respective ones of the map components of a next-higher resolution level relative to the particular node, wherein the segment values and the plurality of node values form a one-way tree with the node value of a lowest-resolution level of the plurality of levels of resolution of the map area being a root value of the one-way tree; and digitally sign the root value of the one-way tree to produce a digitally-signed root value, wherein the authenticated multi-resolution map comprises the segment values, the plurality of node values, and the digitally-signed root value.

Implementations of such a storage medium may include one or more of the following features. The storage medium includes instructions configured to cause the processor to: divide the map area into the map components; and assign the segment values to the segments. The instructions are configured to cause the processor to divide the map area such that a combination of all of the segments span all of the map area. The instructions are configured to cause the processor to assign a non-zero segment value to indicate that the respective sub-area includes a portion of a border of the geographic region of interest. The instructions are configured to cause the processor to divide the map area in accordance with a protocol of segment size and segment arrangement such that the respective sub-area of each segment having a respective segment value of zero is as large as possible in accordance with the protocol of segment size and segment arrangement without the respective sub-area including any portion of the border of the geographic region of interest. The instructions are configured to cause the processor to assign the segment values to indicate whether the respective sub-area is inside the geographic region of interest or outside of the geographic region of interest. The instructions are configured to cause the processor to divide the map area in accordance with a protocol of segment size and segment arrangement such that the respective sub-area of each segment is as large as possible in accordance with the protocol of segment size and segment arrangement while being either completely inside the geographic region of interest or completely outside of the geographic region of interest.

### BRIEF DESCRIPTION OF THE DRAWINGS

FIG. 1 is a schematic diagram of a connected-user equipment transaction system.

FIG. 2 is a block diagram of components of an example of a user equipment shown in FIG. 1.

FIG. 3 is a block diagram of components of an example of roadside equipment shown in FIG. 1.

FIG. 4 is a block diagram of components of an example of a server shown in FIG. 1.

FIG. 5 is a top view of a user equipment communication environment.

FIG. 6 is an example process flow of messages between, and operations of, components of the environment shown in FIG. 5.

FIG. 7 is a block flow diagram of a method of providing an authenticated multi-resolution map.

FIG. 8A is a simplified diagram of a map including a geographic region of interest.

FIG. 8B is a simplified diagram of a map including a geographic region of interest and portions of a multi-resolution map including the geographic region of interest.

FIG. 8C is a pixelated resolution layer of the multi-resolution map shown in FIG. 8B.

FIGS. 8D is a pixelated resolution layer of the multi-resolution map shown in FIG. 8B, or coarser resolution than the layer shown in FIG. 8C.

FIG. 9 is a simplified diagram of portions of an example one-way tree corresponding to the multi-resolution map shown in FIG. 8B.

FIG. 10 is a block flow diagram of a method of determining presence in a geographic region.

FIG. 11A is a simplified diagram of a map including a geographic region of interest, with the map pixelated and analyzed to identify pixels inside the geographic region of interest and pixels outside the geographic region of interest.

FIG. 11B is a simplified diagram of segments of the map shown in FIG. 11A and segment values corresponding to the segments and indicating whether the segments are inside or outside of the geographic region of interest.

FIG. 12 is a block flow diagram of a method of providing an authenticated multi-resolution map.

FIG. 13 is a block flow diagram of a method of determining presence in a geographic region.

FIG. 14 is a simplified block diagram of an example of the user equipment shown in FIG. 2.

### DETAILED DESCRIPTION

Techniques are discussed herein for determining whether a point is inside of a geographic region. For example, a multi-resolution map may be produced with different levels of resolution. Each level of lower-resolution may be a compressed version of a higher-resolution level, e.g., the next higher resolution level. A recipient user equipment (UE) that receives a message regarding a requesting UE may want to determine whether the requesting UE is within a geographic region of interest, which may be indicated by a label provided in a message from the requesting UE along with a location of the requesting UE. The recipient UE may not have a map including the geographic region of interest and the location of the requesting UE, and thus may request such a map from a map distributor UE. The map distributor UE may find an appropriate multi-resolution map stored at the map distributor UE, or may obtain such a map from another source such as a server. If the map indicates whether respective portions contain part of the border of the region of interest, the map distributor UE may analyze the multi-resolution map and provide to the recipient UE portions of the map that include a path from the location of the requesting UE to an edge of the map, and further portions of the map that, combined with the path portions, can be used to determine a root value of the map. If the map indicates whether respective portions are inside or outside of the region of interest, the map distributor UE may send a portion corresponding to the location of the requesting UE and further portions of the map that, combined with the portion including the location of the requesting UE, can be used to determine a root value of the map. The map distributor UE may also provide a digitally-signed root value for the map, with the digitally-signed root value having been signed with a certificate of a trusted source such as a server. The recipient UE may calculate the root value using the portions of the map provided by the map distributor UE, and may then use the calculated root value and the signature on the digitally-signed root value as inputs to a cryptographic verification operation to verify that the information provided by the map distributor may be trusted (e.g., relied upon). For the provided-path scenario, the recipient UE may determine that the path provided by the map distributor extends from the location of the requesting UE to an edge of the map and is contiguous. The recipient UE may determine that the location of the requesting UE is outside or inside of the geographic area of interest based on how many times the path from the location of the requesting UE crosses a border of the geographic region of interest along the path from the location to the edge of the map. For the scenario where the map portions indicate whether the respective portion is inside or outside of the region of interest, the recipient UE may determine that the location of the requesting UE is inside or outside of the region based on a value of the portion of the map that includes the location of the requesting UE. Other configurations, however, may be used.

Items and/or techniques described herein may provide one or more of the following capabilities, as well as other capabilities not mentioned. Information from which a determination may be made as to whether a location is inside of a geographic region may be provided efficiently, e.g., with a relatively small amount of data and/or in a relatively short amount of time. For example, conveying only information for a path from the location to a map edge and other information from which to derive a root value of the map will, under almost all circumstances, use much less data and time than conveying high-resolution data for the entire map. Data transfers of orders of magnitude smaller may be transferred compared to transferring highest-resolution data for an entire map including a point of interest and a geographic region of interest. Other capabilities may be provided and not every implementation according to the disclosure must provide any, let alone all, of the capabilities discussed. It may be possible for an effect noted above to be achieved by means other than that noted, and a noted item/technique may not necessarily yield the noted effect.

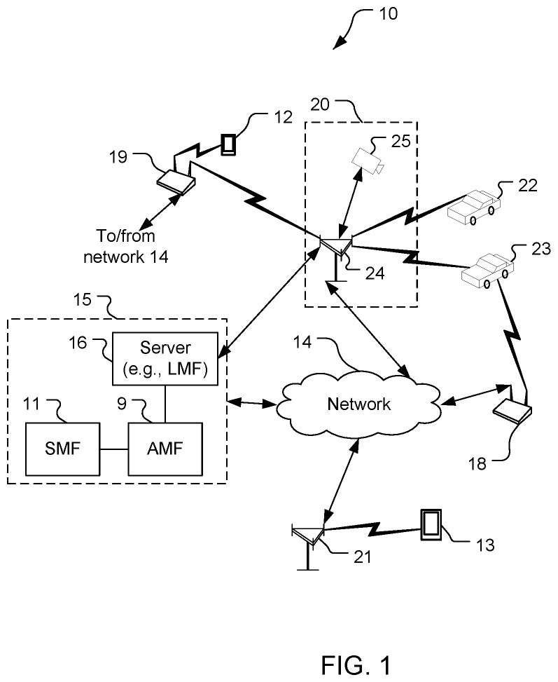

Referring to FIG. 1, an example user equipment (UE) transaction system 10 includes UEs 12, 13, 22, 23, a network 14, a core network 15, access points (APs) 18, 19, roadside equipment (RSE) 20, and a base transceiver station (BTS) 21. The UE transaction system 10 may included a connected-vehicle system and/or other connected-UE systems. The core network 15 (e.g., a 5G core network (5GC)) includes back-end devices including, among other things, an Access and Mobility Management Function (AMF) 9, a Session Management Function (SMF) 11, and a server 16 communicatively coupled to the SMF 11 and the AMF 9. The server 16 may be, for example, a Location Management Function (LMF) that supports positioning of the UEs 12, 13, 22, 23 (e.g., using techniques such as Assisted GNSS (A-GNSS), OTDOA (Observed Time Difference of Arrival, e.g., Downlink (DL) OTDOA and/or Uplink (UL) OTDOA), Round Trip Time (RTT), Multi-Cell RTT, RTK (Real Time Kinematic), PPP (Precise Point Positioning), DGNSS (Differential GNSS), E-CID (Enhanced Cell ID), AoA (Angle of Arrival), AoD (Angle of Departure), etc.). The LMF may also be referred to as a Location Manager (LM), a Location Function (LF), a commercial LMF (CLMF), or a value-added LMF (VLMF). The server 16 (e.g., an LMF), and/or the network, and/or the BTS 21, and/or a BTS 24 (e.g., a gNB) of the RSE 20, and/or the UE 12, 13, 22, 23 may be configured to determine location of the UE 12, 13, 22, 23. The server 16 may communicate directly with the BTS 24 (e.g., a gBNB), may be co-located with the BTS 24, and may be integrated with the BTS 24. The SMF 11 may serve as an initial contact point of a Service Control Function (SCF) (not shown) to create, control, and delete media sessions. The AMF 9 may serve as a control node that processes signaling between the UEs 12, 13, 22, 23 and the core network 15, and provides QoS (Quality of Service) flow and session management. The AMF 9 may support mobility of the UEs 12, 13, 22, 23 including cell change and handover and may participate in supporting signaling connection to the UEs 12, 13, 22, 23. The RSE 20 may include, as shown, the BTS 24 and one or more sensors, in this example, a camera 25. The RSE 20 may be configured differently, e.g, may be a standard base station (e.g., not including the sensor(s)) such as a gNB, may be integrated into a base station such as a gNB, and/or may be integrated into another object or device (e.g., a light post, a building, a sign, etc.). The RSE 20 may be called roadside units (RSUs) or other names. The RSE 20 may or may not be disposed in a vicinity (e.g., within wireless communication range) of a road and thus the term “roadside” does not limit a location of the RSE 20. The system 10 is capable of wireless communication in that components of the system 10 can communicate with one another (at least some times using wireless connections) directly or indirectly, e.g., via the network 14 and/or one or more of the access points 18 and the base transceiver station 21 (and/or one or more other devices not shown, such as one or more other RSEs and/or one or more other base transceiver stations). For indirect communications, the communications may be altered during transmission from one entity to another, e.g., to alter header information of data packets, to change format, etc. The UEs 12, 13 shown are mobile wireless communication devices (although they may communicate wirelessly and via wired connections) including mobile phones (including smartphones) and a tablet computer. The UEs 22, 23 shown are vehicle-based mobile wireless communication devices (although they may communicate wirelessly and via wired connections). The UEs 22, 23 are shown as cars, but these are examples and numerous other configurations of the UEs 22, 23 may be used. For example, one or more of the UEs 22, 23 may be configured as a different type of vehicle such as a truck, a bus, a boat, etc. Further, the quantity of the UEs 22, 23 is an example, and other quantities of UEs may be used. Other UEs may include wearable devices (e.g., smart watches, smart jewelry, smart glasses or headsets, etc.). Still other UEs may be used, whether currently existing or developed in the future. Further, other wireless devices (whether mobile or not) may be implemented within the system 10 and may communicate with each other and/or with the UEs 12, 1, 22, 23, the network 14, the server 16, the APs 18, 19, the RSE 20, and/or the BTS 21. For example, such other devices may include internet of thing (IoT) devices, medical devices, home entertainment and/or automation devices, etc.

The UEs 12, 13, 22, 23 or other devices may be configured to communicate in various networks and/or for various purposes and/or using various technologies (e.g., 5G, Wi-Fi communication, multiple frequencies of Wi-Fi communication, satellite positioning, one or more types of communications (e.g., GSM (Global System for Mobiles), CDMA (Code Division Multiple Access), LTE (Long-Term Evolution), V2X (e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi (e.g., DSRC (Dedicated Short-Range Connection)). The system 10 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc.

The BTSs 21, 24 may wirelessly communicate with the UEs 12, 13, 22, 23 in the system 10 via one or more antennas. A BTS may also be referred to as a base station, an access point, a gNode B (gNB), an access node (AN), a Node B, an evolved Node B (eNB), etc. For example, the BTS 24 may be a gNB or a transmission point gNB. The BTSs 21, 24 may be configured to communicate with the UEs 12, 13, 22, 23 via multiple carriers. The BTSs 21, 24 may provide communication coverage for a respective geographic region, e.g. a cell. Each cell may be partitioned into multiple sectors as a function of the base station antennas.

The system 10 may include only macro BTSs or the system 10 may have BTSs of different types, e.g., macro, pico, and/or femto base stations, etc. A macro base station may cover a relatively large geographic area (e.g., several kilometers in radius) and may allow unrestricted access by terminals with service subscription. A pico base station may cover a relatively small geographic area (e.g., a pico cell) and may allow unrestricted access by terminals with service subscription. A femto or home base station may cover a relatively small geographic area (e.g., a femto cell) and may allow restricted access by terminals having association with the femto cell (e.g., terminals for users in a home).

The UEs 12, 13, 22, 23 may be referred to as terminals, access terminals (ATs), mobile stations, mobile devices, subscriber units, etc. The UEs 12, 13, 22, 23 may include various devices as listed above and/or other devices. The UEs 12, 13, 22, 23 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi Direct (WiFi-D), Bluetooth®, and so on. One or more of a group of the UEs 12, 13, 22, 23 utilizing D2D communications may be within a geographic coverage area of a base station such as one or both of the BTSs 21, 24. Other UEs in such a group may be outside such geographic coverage areas, or be otherwise unable to receive transmissions from a base station. Groups of the UEs 12, 13, 22, 23 communicating via D2D communications may utilize a one-to-many (1:M) system in which each UE may transmit to other UEs in the group. A base station such as the BTS 21 and/or the BTS 24 may facilitate scheduling of resources for D2D communications. In other cases, D2D communications may be carried out between UEs without the involvement of a base station.

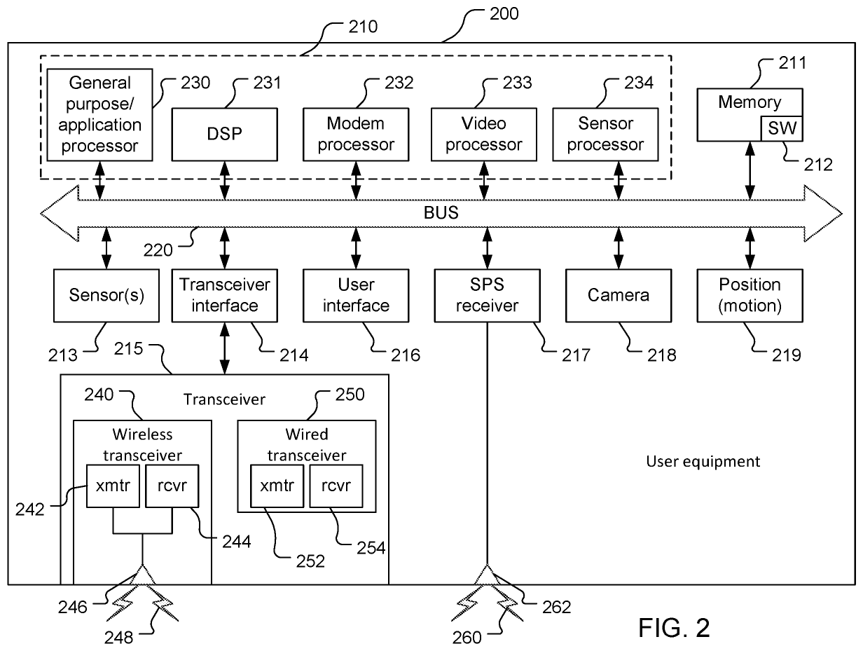

Referring also to FIG. 2, a UE 200 is an example of one of the UEs 12, 13, 22, 23 and comprises a computing platform including a processor 210, memory 211 including software (SW) 212, one or more sensors 213, a transceiver interface 214 for a transceiver 215, a user interface 216, a Satellite Positioning System (SPS) receiver 217, a camera 218, and a position (motion) device 219. The processor 210, the memory 211, the sensor(s) 213, the transceiver interface 214, the user interface 216, the SPS receiver 217, the camera 218, and the position (motion) device 219 may be communicatively coupled to each other by a bus 220 (which may be configured, e.g., for optical and/or electrical communication). One or more of the shown apparatus (e.g., the camera 218, the position (motion) device 219, and/or one or more of the sensor(s) 213, etc.) may be omitted from the UE 200. The processor 210 may include one or more intelligent hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for radar, ultrasound, and/or lidar, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 is a non-transitory storage medium that may include random access memory (RAM)), flash memory, disc memory, and/or read-only memory (ROM), etc. The memory 211 stores the software 212 which may be processor-readable, processor-executable software code containing instructions that are configured to, when executed, cause the processor 210 to perform various functions described herein. Alternatively, the software 212 may not be directly executable by the processor 210 but may be configured to cause the processor 210, e.g., when compiled and executed, to perform the functions. The description may refer only to the processor 210 performing a function, but this includes other implementations such as where the processor 210 executes software and/or firmware. The description may refer to the processor 210 performing a function as shorthand for one or more of the processors 230-234 performing the function. The description may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the processor 230 and/or the DSP 231. Other configurations, however, may be used to perform baseband processing.

The UE 200 may include the sensor(s) 213 that may include, for example, one or more inertial sensors and/or one or more environment sensors. The inertial sensor(s) may comprise, for example, one or more accelerometers (e.g., collectively responding to acceleration of the UE 200 in three dimensions), one or more gyroscopes, and/or one or more magnetometers (e.g., to support one or more compass applications). The environment sensor(s) may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the processor 230 in support of one or more applications such as, for example, applications directed to positioning and/or navigation operations.

The transceiver 215 may include a wireless transceiver 240 and a wired transceiver 250 configured to communicate with other devices through wireless connections and wired connections, respectively. For example, the wireless transceiver 240 may include a transmitter 242 and receiver 244 coupled to one or more antennas 246 for transmitting (e.g., on one or more uplink channels, one or more sidelink channels, and/or one or more downlink channels) and/or receiving (e.g., on one or more downlink channels, one or more sidelink channels, and/or one or more uplink channels) wireless signals 248 and transducing signals from the wireless signals 248 to wired (e.g., electrical and/or optical) signals and from wired (e.g., electrical and/or optical) signals to the wireless signals 248. Thus, the transmitter 242 may include multiple transmitters that may be discrete components or combined/integrated components, and/or the receiver 244 may include multiple receivers that may be discrete components or combined/integrated components. The wireless transceiver 240 may be configured to communicate signals (e.g., with the RSE 20 and/or one or more other RSEs, and/or one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. New Radio may use mm-wave frequencies and/or sub-6GHz frequencies. The wired transceiver 250 may include a transmitter 252 and a receiver 254 configured for wired communication, e.g., with the network 14 to send communications to, and receive communications from, the server 16, for example. The transmitter 252 may include multiple transmitters that may be discrete components or combined/integrated components, and/or the receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The antenna 262 is configured to transduce the wireless signals 260 to wired signals, e.g., electrical or optical signals, and may be integrated with the antenna 246. The antenna 262 is part of the UE 200 even though the antenna 262 is shown outside of the box of the UE 200. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose processor 210, the memory 211, the DSP 231 and/or one or more specialized processors (not shown) may be utilized to process acquired SPS signals, in whole or in part, and/or to calculate an estimated location of the UE 200, in conjunction with the SPS 217. The memory 211 may store indications (e.g., measurements) of the SPS signals 260 and/or other signals (e.g., signals acquired from the wireless transceiver 240) for use in performing positioning operations. The general-purpose processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS imager), a lens, analog-to-digital circuitry, frame buffers, etc. Additional processing, conditioning, encoding, and/or compression of signals representing captured images may be performed by the general-purpose processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position (motion) device (PMD) 219 may be configured to determine a position and possibly motion of the UE 200. For example, the PMD 219 may communicate with, and/or include some or all of, the SPS receiver 217. The PMD 219 may also or alternatively be configured to determine location of the UE 200 using terrestrial-based signals (e.g., at least some of the signals 248) for trilateration, for assistance with obtaining and using the SPS signals 260, or both. The PMD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PMD 219 may include one or more of the sensors 213 (e.g., gyroscopes, accelerometers, etc.) that may sense orientation and/or motion of the UE 200 and provide indications thereof that the processor 210 (e.g., the processor 230 and/or the DSP 231) may be configured to use to determine motion (e.g., a velocity vector and/or an acceleration vector) of the UE 200. The PMD 219 may be configured to provide indications of uncertainty and/or error in the determined position and/or motion.

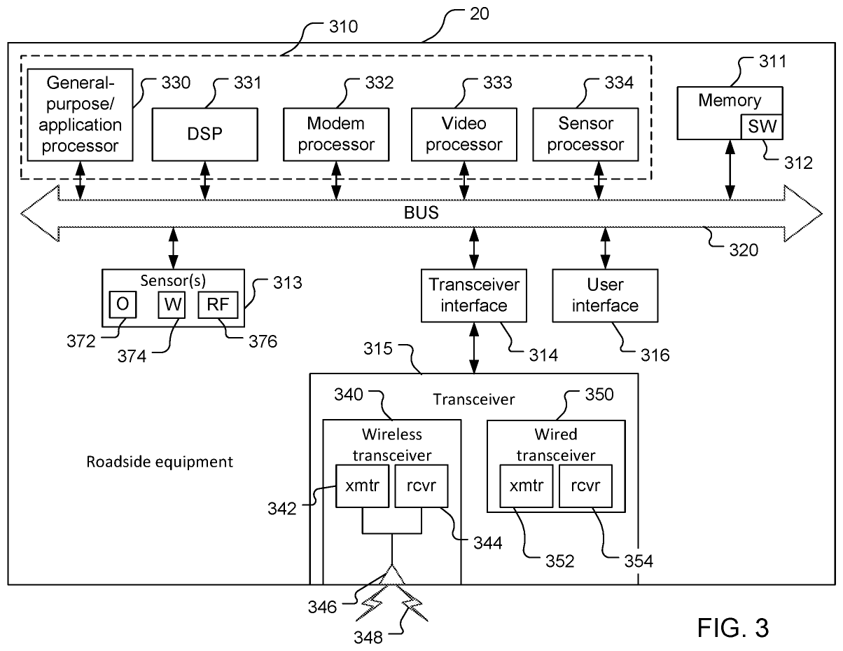

Referring also to FIG. 3, an example of the RSE 20 comprises a computing platform including a processor 310, memory 311 including software (SW) 312, one or more sensors 313, a transceiver interface 314 for a transceiver 315, and a user interface 316. The processor 310, the memory 311, the sensor(s) 313, the transceiver interface 314, and the user interface 316 may be communicatively coupled to each other by a bus 320 (which may be configured, e.g., for optical and/or electrical communication). At least portions of the processor 310, the memory 311, the transceiver interface 314, and the transceiver 315 comprise the RSE base station 24. One or more of the shown apparatus (e.g., the user interface 316) may be omitted from the RSE 20. The processor 310 may include one or more intelligent hardware devices, e.g., a central processing unit (CPU), a microcontroller, an application specific integrated circuit (ASIC), etc. The processor 310 may comprise multiple processors including a general-purpose/application processor 330, a Digital Signal Processor (DSP) 331, a modem processor 332, a video processor 333, and/or a sensor processor 334. One or more of the processors 330-334 may comprise multiple devices (e.g., multiple processors). For example, the sensor processor 334 may comprise, e.g., processors for radar, ultrasound, and/or lidar, etc. The memory 311 is a non-transitory storage medium that may include random access memory (RAM)), flash memory, disc memory, and/or read-only memory (ROM), etc. The memory 311 stores the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions. The description may refer only to the processor 310 performing a function, but this includes other implementations such as where the processor 310 executes software and/or firmware. The description may refer to the processor 310 performing a function as shorthand for one or more of the processors 330-334 performing the function. The description may refer to the RSE 20 performing a function as shorthand for one or more appropriate components of the RSE 20 performing the function. The processor 310 may include a memory with stored instructions in addition to and/or instead of the memory 311. Functionality of the processor 310 is discussed more fully below.

The transceiver 315 may include a wireless transceiver 340 and a wired transceiver 350 configured to communicate with other devices through wireless connections and wired connections, respectively. For example, the wireless transceiver 340 may include a transmitter 342 and receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to wired (e.g., electrical and/or optical) signals and from wired (e.g., electrical and/or optical) signals to the wireless signals 348. Thus, the transmitter 342 may include multiple transmitters that may be discrete components or combined/integrated components, and/or the receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 350 may include a transmitter 352 and a receiver 354 configured for wired communication, e.g., with the network 14 to send communications to, and receive communications from, the server 16, for example. The transmitter 352 may include multiple transmitters that may be discrete components or combined/integrated components, and/or the receiver 354 may include multiple receivers that may be discrete components or combined/integrated components. The wired transceiver 350 may be configured, e.g., for optical communication and/or electrical communication. The transceiver 315 may be communicatively coupled to the transceiver interface 314, e.g., by optical and/or electrical connection. The transceiver interface 314 may be at least partially integrated with the transceiver 315.

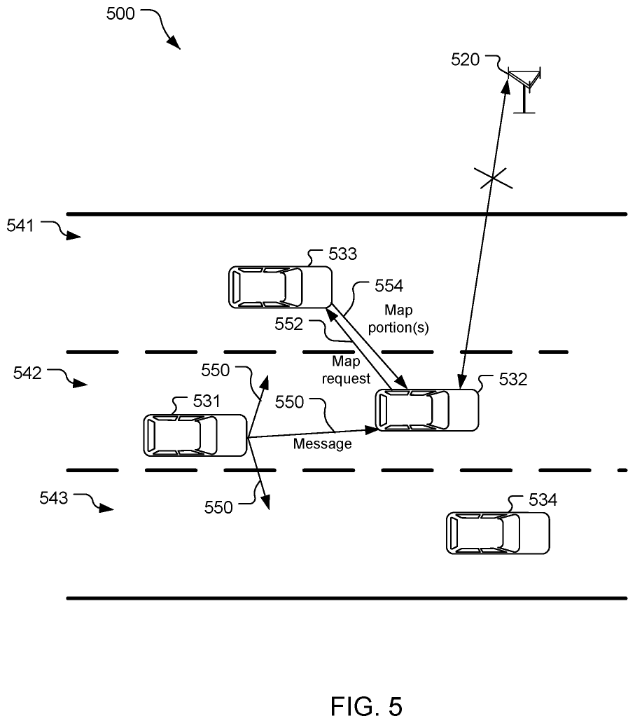

The sensor(s) 313 may include an optical sensor 372, a weight sensor 374, an RF sensor 376, and optionally one or more other sensors not shown. While only one optical sensor 372, one weight sensor 374, and one RF sensor 376 are shown in FIG. 3, and referred to herein in the singular, the optical sensor 372 may include more than one optical sensor, the weight sensor 374 may include more than one weight sensor (e.g., as shown in FIG. 5 and discussed below), and/or the RF sensor 376 may include more than one RF sensor. The optical sensor 372 may be configured to capture one or more images. For example, the optical sensor 372 may include one or more cameras such as the camera 25. The weight sensor 374 may be configured to measure weights of objects such as the UEs 22, 23, and may be configured as one weight sensor or multiple separate weight sensors. The sensors 372, 374 are examples and not limiting of the description as numerous other types and/or quantities of sensors may be used. The RF sensor 376 may be disposed in or near an RF transaction region and configured to sense RF traffic associated with the RF transaction region.

The optical sensor 372 may include one or more cameras for capturing still or moving imagery. The camera(s) may comprise, for example, an imaging sensor (e.g., a charge coupled device or a CMOS imager), a lens, analog-to-digital circuitry, frame buffers, etc. Additional processing, conditioning, encoding, and/or compression of signals representing captured images may be performed by the general-purpose processor 330 and/or the DSP 331. Also or alternatively, the video processor 333 may perform conditioning, encoding, compression, and/or manipulation of signals representing captured images. The video processor 333 may decode/decompress stored image data for presentation on a display device (not shown), e.g., of the user interface 316.

The user interface 316 may comprise one or more of several devices such as, for example, a speaker, microphone, display device, vibration device, keyboard, touch screen, etc. The user interface 316 may include more than one of any of these devices. The user interface 316 may be configured to enable a user to interact with one or more applications hosted by the RSE 20. For example, the user interface 316 may store indications of analog and/or digital signals in the memory 311 to be processed by DSP 331 and/or the general-purpose processor 330 in response to action from a user. Similarly, applications hosted on the RSE 20 may store indications of analog and/or digital signals in the memory 311 to present an output signal to a user. The user interface 316 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 316 may comprise one or more touch sensors responsive to touching and/or pressure, e.g., on a keyboard and/or touch screen of the user interface 316.

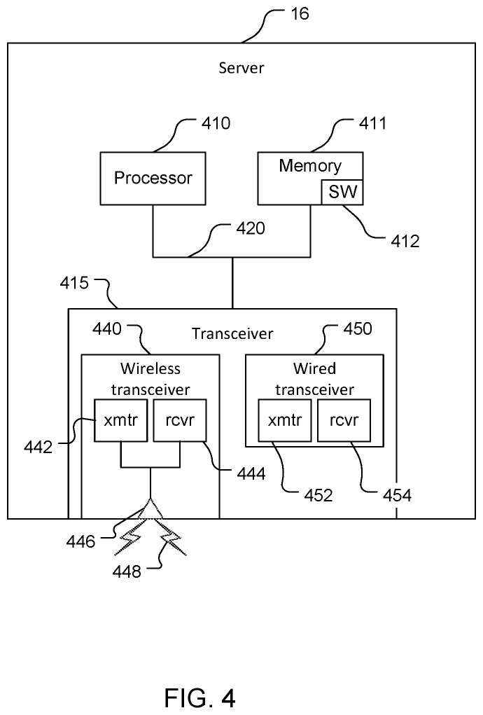

Referring also to FIG. 4, an example of the server 16 comprises a computing platform including a processor 410, memory 411 including software (SW) 412, and a transceiver 415. The processor 410, the memory 411, and the transceiver 415 may be communicatively coupled to each other by a bus 420 (which may be configured, e.g., for optical and/or electrical communication). One or more of the shown apparatus (e.g., a wireless interface) may be omitted from the server 16. The processor 410 may include one or more intelligent hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 is a non-transitory storage medium that may include random access memory (RAM)), flash memory, disc memory, and/or read-only memory (ROM), etc. The memory 411 stores the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description may refer only to the processor 410 performing a function, but this includes other implementations such as where the processor 410 executes software and/or firmware. The description may refer to the processor 410 performing a function as shorthand for one or more of the processors contained in the processor 410 performing the function. The description may refer to the server 16 performing a function as shorthand for one or more appropriate components of the server 16 performing the function. The processor 410 may include a memory with stored instructions in addition to and/or instead of the memory 411. Functionality of the processor 410 is discussed more fully below.

The transceiver 415 may include a wireless transceiver 440 and a wired transceiver 450 configured to communicate with other devices through wireless connections and wired connections, respectively. For example, the wireless transceiver 440 may include a transmitter 442 and receiver 444 coupled to one or more antennas 446 for transmitting (e.g., on one or more downlink channels) and/or receiving (e.g., on one or more uplink channels) wireless signals 448 and transducing signals from the wireless signals 448 to wired (e.g., electrical and/or optical) signals and from wired (e.g., electrical and/or optical) signals to the wireless signals 448. Thus, the transmitter 442 may include multiple transmitters that may be discrete components or combined/integrated components, and/or the receiver 444 may include multiple receivers that may be discrete components or combined/integrated components. The wireless transceiver 440 may be configured to communicate signals (e.g., with the UE 200, one or more other UEs, the RSE 20, one or more other RSEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 450 may include a transmitter 452 and a receiver 454 configured for wired communication, e.g., with the network 14 to send communications to, and receive communications from, the RSE 20 and/or a web server, for example. The transmitter 452 may include multiple transmitters that may be discrete components or combined/integrated components, and/or the receiver 454 may include multiple receivers that may be discrete components or combined/integrated components. The wired transceiver 450 may be configured, e.g., for optical communication and/or electrical communication.

Referring also to FIG. 5, a UE communication environment 500 includes a base station 520, and UEs 531, 532, 533, 534, in this example vehicles traveling in lanes 541, 542, 543, respectively. In the environment 500, one or more of the UEs 531-534 (here, vehicles) may send a message indicative of a geographic region and corresponding functionality, and possibly requesting one or more actions in accordance with the functionality. For example, emergency vehicles (e.g., police cars, ambulances, firetrucks) may be entitled to certain functionality, at least within the geographic region. Examples of functionality may include traffic light preemption, other vehicle deference (e.g., yielding by other vehicles to the vehicle sending the message), etc. The requesting vehicle may be entitled to the functionality only when the requesting vehicle is in the geographic region. Vehicles receiving a message from the requesting vehicle may confirm that the requesting vehicle is in the geographic region and entitled to the functionality before taking an action in accordance with the functionality (e.g., yielding to the requesting vehicle). The receiving vehicle may not have information, e.g., a map, from which the receiving vehicle can determine whether the requesting vehicle is in the geographic region. For example, the geographic region may have been recently defined or changed, the receiving vehicle may have entered a location with different geographic regions and not yet obtained information for those regions, etc. If the vehicle receiving the message does not have information, e.g., a map, from which the receiving vehicle can determine whether the requesting vehicle is in the geographic region, and cannot retrieve such information at all or at least within a timely manner, e.g., via a wireless communication connection (e.g., WiFi, cellular) to the base station 520, then the receiving vehicle may request the information from another vehicle, e.g., using a short-range wireless communication protocol such as Bluetooth®. In order to request and obtain the information from which the receiving vehicle can determine whether the requesting vehicle is in the geographic region quickly, the request from the receiving vehicle and the information returned to the receiving vehicle may comprise small amounts of data.

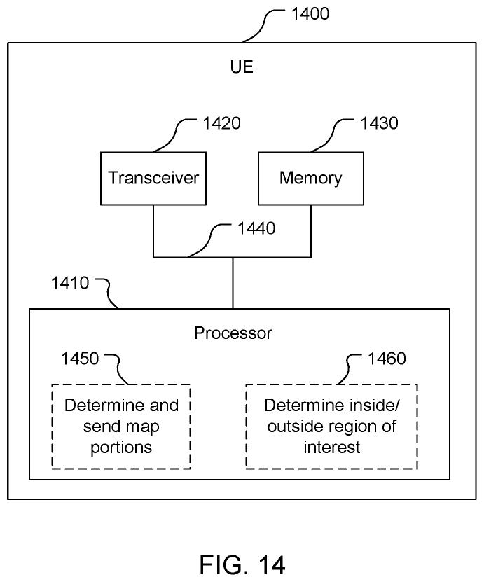

Referring also to FIG. 14, the UEs 531-534 may be examples of a UE 1400, which is an example of the UE 200 shown in FIG. 2. The UE 1400 includes a processor 1410, a transceiver 1420, and a memory 1430 communicatively coupled to each other by a bus 1440. The transceiver 1420 may be configured similarly to the transceiver 215 (and may include the antenna 246) and the memory 1430 may be configured similarly to the memory 211, e.g., including software with processor-readable instructions configured to cause the processor 1410 to perform functions. The description may refer only to the processor 1410 performing a function, but this includes other implementations such as where the processor 1410 executes software (stored in the memory 1430) and/or firmware. The description may refer to the UE 1400 (or any of the UEs 531-534) performing a function as shorthand for one or more appropriate components (e.g., the processor 1410 and the memory 1430) of the UE 1400 (or any of the UEs 531-534) performing the function. The processor 1410 (possibly in conjunction with the memory 1430 and, as appropriate, the transceiver 1420) may include a determine and send map portions functional unit 1450 for determining and sending portions of maps as discussed herein (e.g., stages 610, 612 discussed below). The processor 1410 (possibly in conjunction with the memory 1430 and, as appropriate, the transceiver 1420) may also or alternatively include a determine inside/outside region of interest functional unit 1460 for using received map portions to verify (e.g., as discussed below for stage 622) whether another UE is in a region in which the other UE is authorized to receive one or more services, e.g., priority in traffic. Such functions are discussed further herein, and the description may refer to the processor 1410 generally, or the UE 1400 generally (or any of the UEs 531-534 generally), as performing any of these functions. The function units 1450, 1460 may be implemented in hardware, such as the processor 1410, or elsewhere in the UE 1400, such as in the memory 1430 (e.g., in software), or a combination thereof.

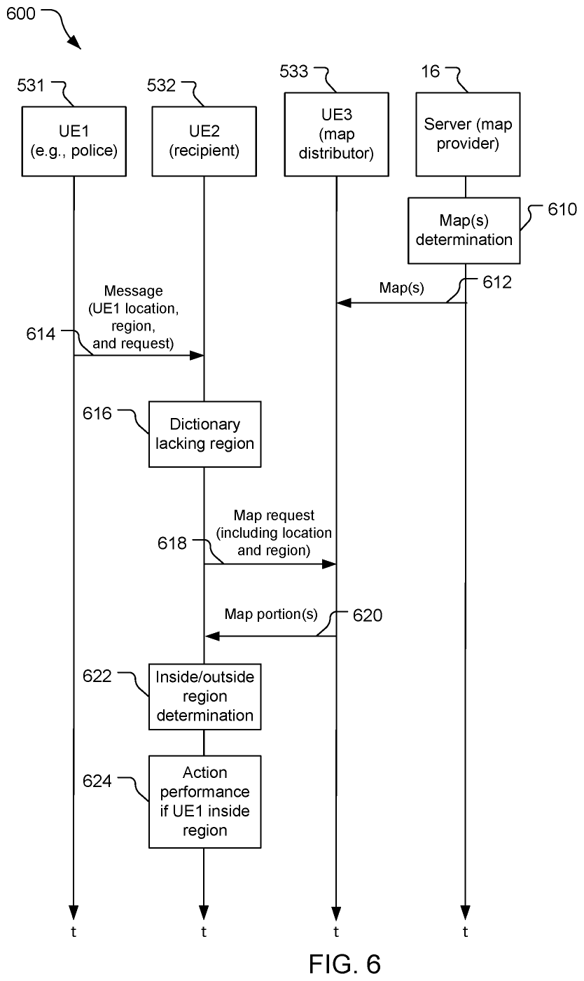

Referring also to FIG. 6, a call and process flow 600 shows signaling between the UEs 531, 532, 533 and the server 16 in order for the UE 532 to obtain information in order to answer the question of whether the UE 531 is in an identified geographic region for requested functionality. The server 16 may be configured to produce one or more maps, at stage 610, that include geographic regions that may correspond to various functionality. The geographic regions may be called validity regions as they may correspond to regions that are valid for a UE, such as a vehicle, to request one or more functions. The server 16 may be configured to produce maps that each have multiple levels of resolution or granularity, that are each signed to ensure that the map is authentic and produced by a trusted source, and whose signature may be verified by data from any resolution level of the map or a combination of data from different levels as long as the combination covers the entire span of the map.

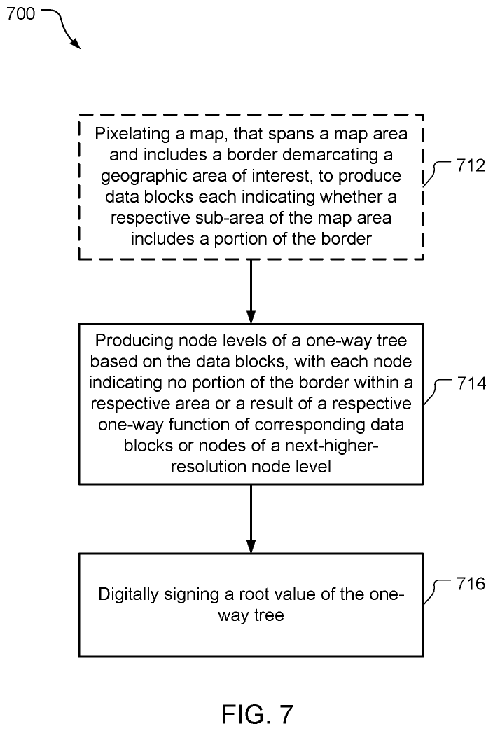

Referring to FIG. 7, with further reference to FIGS. 1-6, a method 700 of providing an authenticated multi-resolution map includes the stages shown. The method 700 is, however, an example only and not limiting. The method 700 may be altered, e.g., by having stages added, removed, rearranged, combined, performed concurrently, and/or having single stages split into multiple stages. For example, the stage 712 may be omitted, e.g., if a pixelated map is provided.

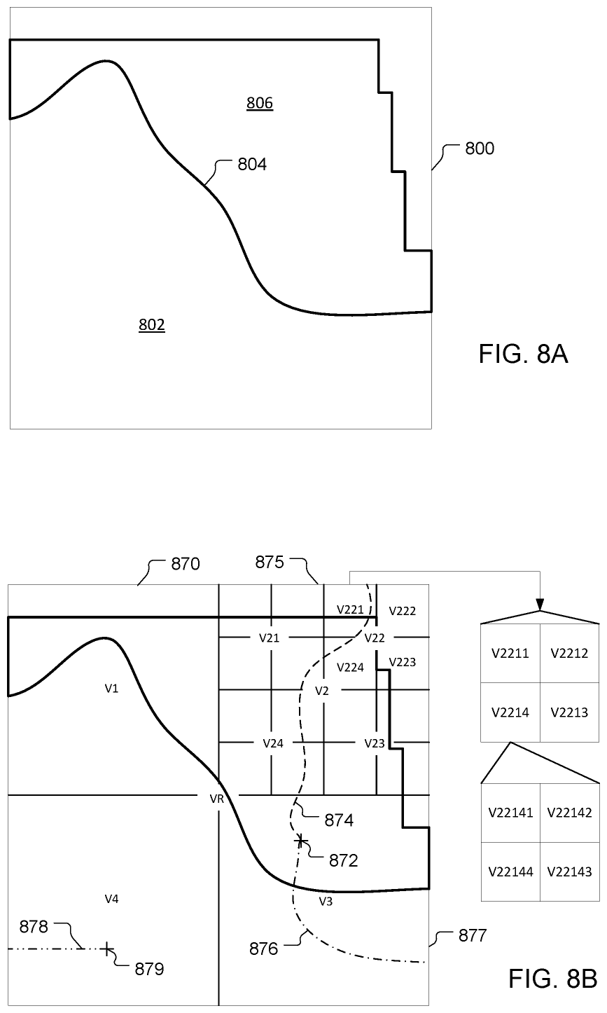

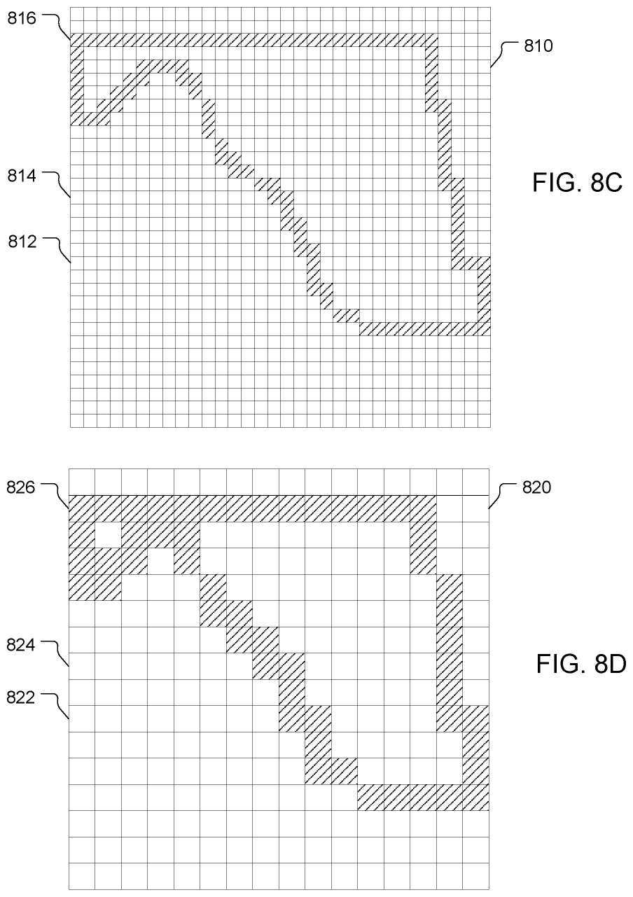

At stage 712, the method 700 may include pixelating a map to produce data blocks, where the map spans a map area and includes a border demarcating a geographic area of interest, and where each of the data blocks indicates whether a respective sub-area of the map area includes a portion of the border. For example, referring also to FIGS. 8A, 8C, the server 16 (e.g., the processor 410 possibly in conjunction with the memory 411) may analyze a map 800 that spans a map area 802 and includes a border 804 of a geographic area of interest 806 (which may also be called a geographic region of interest). The geographic area of interest 806 may be any region such as a city, a county, a state, a lake, an area code, etc. The geographic area of interest 806 may be a human construct (e.g., a city), an environmental area (e.g., a basin, a mountain, a valley, etc.), etc. The server 16 may obtain a pixelated version of the map 800 (e.g., from the memory 411 or from a remote device) and/or may pixelate the map 800 (divide the map into pixels that in combination cover the map area 802). For example, the server 16 may pixelate the map 800 into a pixelated map layer 810 of data blocks 812, with each empty data block 814 indicating that the sub-area of the map area 802 corresponding to that empty data block 814 does not contain (lacks) any portion of the border 804, and with each non-empty data block 816 indicating that the sub-area of the map area 802 corresponding to that non-empty data block 816 contains a portion of the border 804. The layer 810 may be called a level or a data block level. Each of the data blocks 812 may correspond to a selected area, e.g., a 1 m×1 m area. Here, the data blocks 812 are square areas, but other shapes (e.g., non-square rectangles, hexagons, etc.) of data blocks may be used. Having the data blocks 812 (and nodes, discussed further below) be non-overlapping but abutting (and thus of shapes such as rectangles or hexagons) may facilitate calculation of the nodes. The pixelated map layer 810 is a visual representation of the pixelated map. A numerical representation of the pixelated layer 810 may comprise numerical values for the data blocks 812, e.g., with a zero indicating that the sub-area of the map area 802 corresponding to that data block 812 does not contain (lacks) any portion of the border 804, and with a one indicating that the sub-area of the map area 802 corresponding to that data block 812 contains a portion of the border 804. The processor 410 (possibly in combination with the memory 411) may comprise means for pixelating a map.

At stage 714, the method 700 may include producing node levels of a one-way tree based on the data blocks, with each node indicating no portion of the border within a respective area, or a respective one-way function of corresponding data blocks (for a highest-resolution node level) or of corresponding nodes of a next-higher-resolution node level. Multiple one-way functions may be used to determine the one-way tree, e.g., different one-way functions for different levels of the one-way tree. A one-way function is a function that is impractical (though not necessarily impossible) to reverse, i.e., to determine the input from the output. For example, an amount of computing power and/or time to reverse the one-way function is(are) so high, that a likelihood of the one-way function being reversed is acceptably low. An example of a one-way function is a cryptographic hash function, or simply a hash. The discussion herein refers to a hash tree (also known as a Merkle tree) and hashes, but the description applies to other examples of one-way functions, and thus other examples of one-way trees. As shown in FIG. 8D, the server 16 may produce a highest-resolution node level 820 that comprises nodes 822 each of which corresponds to four of the data blocks 812. Each blank node 824 indicates that the area covered by the node 824 contains no portion of the border 804 of the geographic region of interest, and each non-empty node 826 indicates that the area covered by the node 826 contains a portion of the border 804 of the geographic region of interest. In this example, each non-empty node 826 in the node level 820 comprises a value of a hash of the four data blocks 812 spanned by the node 826. The nodes 822 in the node level 820 may correspond to other quantities of data blocks 812, e.g., two data blocks 812 each. The data blocks 812 and the various nodes may be called grid elements even though data blocks and/or nodes may not be arranged in a grid. The processor 410 (possibly in combination with the memory 411) may comprise means for producing node levels of a hash tree.

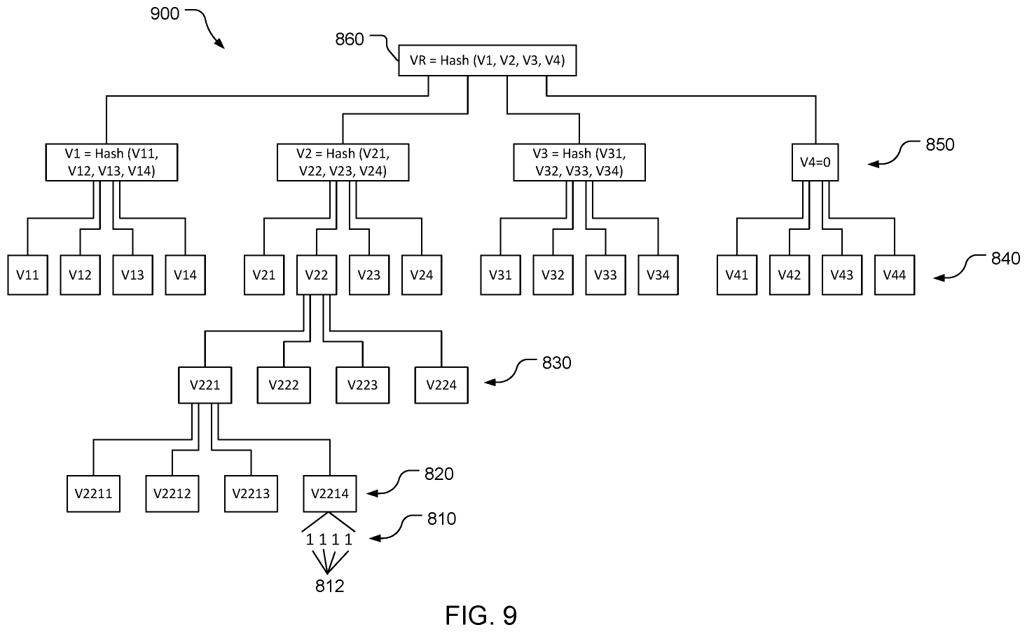

Further node levels may be produced by the server 16, with each node of a particular layer having a value that indicates that no portion of the border 804 is covered by the area of that node, or has a value of a hash of the nodes in the next-higher-resolution layer covered by that node. Thus, referring also to FIGS. 8B and 9, node levels and portions of node levels are shown in a multi-resolution map 870 and a hash tree 900 (indicative of the multi-resolution map 870). The description assumes a hash tree, but the description (including the term “hash tree”) applies equally well to other forms of one-way trees (i.e., trees using one or more one-way functions that may be one or more hash functions and/or one or more other one-way functions). Less than all of the nodes are shown in FIGS. 8B and 9 to reduce complexity while illustrating the multi-resolution concept. The hash tree 900 includes the data blocks 812 of the pixelated map layer 810 at the lowest level of the hash tree 900, which is the highest-resolution level of the hash tree 900. One level above the data blocks 812 is the highest-resolution node level 820, with further node levels 830, 840, 850 in decreasing resolution. A root hash value (Value of Root (VR)) 860 is a hash of the node values of the highest-level node layer 850 (i.e., the lowest-resolution node layer), or zero if no portion of the border 804 is within the area corresponding to the node. The description herein assumes the example of a hash tree, and thus of a root hash value, but the description applies to root values derived using other one-way functions. A value (V) of each of the nodes comprises a hash of the corresponding nodes in the next lower (next higher resolution) layer. The values are indicated with labels of one or more numbers after the letter “V”. The numbers correspond to the quadrant or sub-quadrant of the respective value in the respective level in the hash tree 900 or multi-resolution map 870 (e.g., VMN is the value of the N^{th} sub-quadrant in the level 840 of the M^{th} quadrant in the level 850). A sub-quadrant corresponds to a quadrant within the quadrant of the next-higher level (i.e., next-lower-resolution level) of the hash tree 900 or the multi-resolution map 870. Thus, for example, the node value V223 indicates the value of the node corresponding to the third quadrant of the level 830 that is within the second quadrant of the level 840 that is within the second quadrant of the level 850. The levels 810, 820, 830, 840, 850 may also be called layers. In the data block level, the values correspond to whether the area includes a portion of the border 804 rather than a hash as there is no lower level. Thus, as shown in FIG. 8B, the values V22141, V22142, V22143, V22144 are data block values rather than node values. The value designations may also be used to refer to the node or data block areas, e.g., the node V2214 or the data block V22144. The hash tree 900 is an example only, and hash trees, corresponding to multi-resolution maps, with more or fewer levels may be used, and/or with other quantities of values at a level corresponding to a node value at the next-higher level, and/or with different quantities of values of lower levels corresponding to node values at the next-higher level (e.g., some nodes may correspond to two values of the next-lower level while other nodes may correspond to four values of the next-lower level).

The root hash value 860 may be determined from values of one or more of the levels 810, 820, 830, 840, 850 of the hash tree 900. The root hash value 860 may be derived from any combination of the data blocks 812 or the node values that correspond to areas that in combination cover the entire map area 802. Thus, for example, the root hash value 860 may be determined from all of the data blocks 812, or all of the node values of a single node level, or a combination of data blocks and/or node values that in combination cover the entire map area 802. For any given data block value, the root hash value may be determined if the other data block values corresponding to the same lowest-level node are provided, the node values of the lowest node level for nodes not derived from the known/provided data block values are provided, and for each higher node level the non-derived node values are provided. That is for each level for which the node value is derived, to derive (calculate) the next-higher node value, only the other node values of the same level as the derived node values needs to be provided. This is the minimum amount of data block and node information to determine the root hash value 860, with the highest-level (lowest-resolution) node information being provided. More map information (data block value(s) and/or node value(s)) may be provided. For example, if the data block value V22132 is known, then the root hash value may be determined (e.g., by the UE 200) if the data block values V22131, V22133, V22134, the node values V2211, V2212, V2214 of the node level 820, the node values V222, V223, V224 of the node level 830, the node values V21, V23, V24 of the node level 840, and the node values V1, V3, V4 of the node level 850 are provided.

Referring again to FIG. 7, with continued further reference to FIGS. 1-6, 8, and 9, at stage 716 the method 700 may include digitally signing a root value of the one-way tree. For example, the server 16 (e.g., the processor 410 (possibly in combination with the memory 411)) digitally signs the root hash value 860 of the hash tree 900 using a digital certificate to provide a digital signature to the root hash value 860. The server 16 may provide the digital certificate to other entities including, for example, the UEs 12, 13, 22, 23. The other entities may use the digital certificate to verify that information provided to the UEs 12, 13, 22, 23 is reliable. For example, as discussed further herein, the digitally signed root hash value may be provided along with other information from which the root hash value 860 may be calculated, and the receiving entity may use the public key from the signer's digital certificate, along with the signature calculated to create the digitally signed root hash value, to confirm that the calculated root hash value is equal to the root hash value that was digitally signed. The digitally signed root hash, the data blocks, and the node values produced by the server 16 comprise the authenticated multi-resolution map, e.g., the multi-resolution map 870 combined with the digitally signed root hash value comprises the authenticated multi-resolution map. The processor 410 (possibly in combination with the memory 411) may comprise means for digitally signing the root hash of the hash tree.

Referring again to FIG. 6, with continued further reference to FIGS. 1-5, and 7-9, at stage 612, the flow 600 includes the server 16 sending one or more maps to the UE 533. The server 16 may send the one or more maps (e.g., authenticated multi-resolution maps) to one or more entities in addition to the UE 533. The UE 533 may store the map(s) provided by the server 16 in the memory 211. The stages 610, 612 typically occur before other stages of the flow 600, but this is not required. For example, the stage 612 could occur after stage 618 discussed below, and may occur in response to a request, here from the UE 533.

At stage 614, the flow 600 includes the UE 531 sending a message to the UE 532. The UE 531 may send the message to one or more other entities as well, e.g., by broadcasting the message. As shown in the example of FIG. 5, the UE 531 (which may be an example of the UE 200) may send a broadcast message 550 that may be received by any entity within communication range. The message, e.g., the message 550, may include an identifier of a geographic region and a location of the UE 531. The identifier could be a name of the geographic region corresponding to functionality to which or for which the UE 531 is entitled (approved). The identifier could be an explicit region name or an implicit name (e.g., an identity of the UE 531 could be associated with a geographic region). The identifier may be a name of the geographic region that is associated with (e.g., mapped to) a border of the geographic region by a dictionary of identifier-region pairs. For example, the name of the region may be mapped to a polygon of the boundary of the geographic region, with a known location, e.g., global location, of the polygon. For example, the name “Wallace County” may be mapped to the border 804 of the geographic region of the geographic area of interest 806. One or more maps, e.g., provided by the server 16, may include (span at least) the geographic region and include global location indicators (e.g., latitude and longitude values).

At stage 616, the UE 532 receives the message 550 and attempts to find a map that includes the geographic region corresponding to the identifier. For example, the processor 210 of the UE 532 may search a look-up table in the memory 211 containing identifier-region pairs. If the UE 532 finds the identifier in the identifier-region pairs, then the UE 532 may access (e.g., read) a map stored in the memory 211 containing the corresponding region. If the UE 532 finds the identifier in the identifier-region pairs, or finds the identifier in the identifier-region pairs but there is no corresponding map stored in the memory 211, then the UE 532 may send a map request for information that will permit the UE 532 to determine whether the location of the UE 531 is within the region corresponding to the identifier.

At stage 618, the UE 532 sends a map request message 552 (see FIG. 5) that includes indications of the location of the UE 531 and the geographic region of interest. The indication of the geographic region of interest may be the identifier provided by the UE 531. The map request may not specifically request a map, and may be an implicit request. For example, the map request may include the location of the UE 531 and the identifier of the geographic region, and this information may imply a request for information from which the UE 532 may determine whether the indicated location is within the corresponding geographic region. The request may include a request for a mechanism for authenticating the information provided. The UE 532 may request information from which the UE 532 may determine whether the indicated location is within the corresponding geographic region rather than the conclusion of whether the indicated location is within the corresponding geographic region to help ensure that such a determination is valid (e.g., not a false conclusion sent by the UE 533). This may help the UE 533 accurately determine whether the UE 531 is within a geographic region, e.g., corresponding to functionality being requested (explicitly or implicitly) by the UE 531.

At stage 620, the UE 533 responds to the received map request by providing one or more map portions 554 (see FIG. 5) to the UE 532 to enable the UE 532 to determine whether the indicated location is within the corresponding geographic region. One or more of the map portions may be compressed, e.g., of reduced data size compared to full map information (e.g., a node value from the hash tree 900 rather than a data block value). Further, additional compression may be provided for consistent portions of the border 804 (e.g., for significantly-long straight sections and/or significantly-long consistently-curved portions (smooth curves)). The processor 210 of the UE 533 may find a map stored in the memory 211 of the UE 532 that includes the geographic region of interest, e.g., corresponding to the identifier provided by the UE 532 (corresponding to the identifier provided by the UE 531), and the location of the UE 531. For example, the UE 533 may find the multi-resolution map 870 that includes the geographic area of interest 806 corresponding to the border 804, either or both of which correspond to the identifier, and that includes the location, in this example a location 872. The UE 533 may select a path from the location 872 to an edge of the map 870. A path may be selected in a variety of manners, e.g., a straight line to a nearest edge, or by one or more other techniques known now or developed in the future. For example, the UE 533 may select a path 874 to an edge 875 of the map 870, or may select a path 876 to an edge 877 of the map 870. The paths 874, 876 are examples only, and any of numerous other paths may be selected. For example, a straight path may be selected from the location 872 to an edge of the map 870. The UE 533 may provide portions of the map 870 from the location 872 along one or more of the paths to a respective edge of the map 870.

The UE 533 selects portions of the map 870 from the location 872 to an edge of the map 870 along a selected path. For example, UE 533 may select a corresponding one of the data blocks 812 for each crossing of the border 804 by the selected path and may select the highest-level (lowest-resolution) portion of the map 870 (node or data block) possible for sections of the selected path that do not cross the border 804. The path is considered to cross the border 804 as soon as the path reaches the border 804, e.g., even if the path does not extend to the other side of the border 804 (e.g., if the border 804 coincided with an edge of the map 870), The selected map portions may include data blocks that do not cover any portion of the border 804 by that are within a lowest-level (highest-resolution) node that includes a data block that lies along the selected path and that does include the border 804. In this way, the UE 533 may select the minimum number of data block(s) (if any) and/or node(s) of the map 870 that include the path from the location 872 to the respective edge reached by the selected path. For example, the UE 533 may select the nodes V312, V243, V242, V213, V224 (with nodes V312, V243, V242, V213 not specified in FIG. 8B to reduce complexity of the figure) and the data blocks V22133, V22132 as path portions of the map 870 for the path 874. The UE 533 may further select, in addition to the path portions of the map 870, one or more other nodes (as appropriate) of the map 870 to enable the UE 532 to determine the root hash value 860. The UE 533 may select the minimum amount of other node(s) needed to determine the root hash value 860 in order to minimize the amount of map information passed to the UE 532 to determine whether the UE 531 is within the geographic region indicated by the UE 531. For the example of the path 874 and the path portions noted, the UE 533 may further select data blocks V22131, V22134 and nodes V2211, V2212, V2214, V222, V223, V224, V21, V23, V24, V1, V3, V4. The UE 533 may provide the selected data block values, selected node values, and the digitally signed root hash value to the UE 532 at stage 620.

At stage 622, the UE 532 may determine whether the requesting UE, in this example the UE 531, is within the geographic validity region, in this example, the geographic area of interest 806 (within the border 804). For example, the UE 532 (e.g., the processor 210 (possibly in conjunction with the memory 211) of the UE 532) may analyze the map portions 554 (e.g., data block(s), if any, and node value(s), if any) provided by the UE 533 at stage 620 to determine the root hash value 860. The UE 532 may use the digital certificate corresponding to the provided map portions (e.g., corresponding to the server 16 or the map 870) to determine whether the digitally signed root hash value provided by the UE 533 matches the root hash value determined from the map portions provided by the UE 533. The UE 532 may determine whether the path portions provided by the UE 533 include the location of the UE 531, determine whether the path portions are contiguous from that location to an edge of the map 870, and determine whether the path portions indicate that the location 872 is within the geographic area of interest 806. To determine whether the path portions indicate that the location 872 is within the geographic area of interest 806, the UE 532 may count a number of crossings of the border 804 included in the provided path portions of the map 870. If the number of border crossings is odd, then the UE 532 determines that the location 872 is within the geographic area of interest 806 and if the number of border crossings is zero or even, then the UE 532 determines that the location 872 is not within (is outside) the geographic area of interest 806. The UE 532 may analyze the map portions to determine the root hash value only if the UE 532 first determines that the location 872 is within the geographic area of interest 806. Alternatively, the UE 532 may determine that the location 872 is within the geographic area of interest 806 only if the UE first determines that the root hash value determined from the map portions matches the digitally signed root hash value.

At stage 624, the UE 532 may provide functionality in accordance with (e.g., in response to) the determination made at stage 622. For example, the UE 532 may take an action if the UE 532 determined that the UE 531 is within the geographic area of interest 806. For example, the UE 532 may determine to yield to an approaching emergency vehicle, e.g., moving from the lane 542 to the lane 543 if the UE 532 is an autonomous-driving vehicle or providing driving guidance (e.g., providing an indication to a driver of the UE 532 to change lanes (and possibly providing further assistance data, e.g., that a blind zone is clear)) if the UE 532 is not an autonomous-driving vehicle or is in a manual-driving mode. As another example, the UE 532 may not take an action if the UE 531 was determined not to be in the geographic area of interest 806. As another example, the UE 532 may provide information to the UE 531 in response to the UE 531 being within the geographic area of interest 806. As another example of providing functionality in accordance with the determination made at stage 622, the UE 532 may abstain from taking an action in response to the UE 531 being within the geographic area of interest 806. For example, the UE 531 may transmit (e.g., broadcast) a message indicating that a particular road is closed and where, along with an indication (via the validity region mechanism) that the UE 531 is authorized to send road-closure messages in that region. This may help prevent a non-mobile but portable device that might send such a message from being picked up by a malicious actor and moved to a location where the device would send incorrect messages.

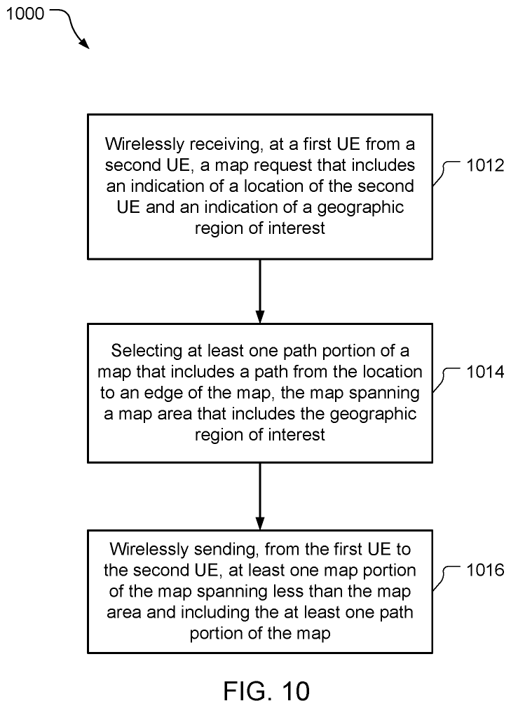

Referring to FIG. 10, with further reference to FIGS. 1-9, a method 1000 of providing positioning information includes the stages shown. The method 1000 is, however, an example only and not limiting. The method 1000 may be altered, e.g., by having stages added, removed, rearranged, combined, performed concurrently, and/or having single stages split into multiple stages. Positioning information comprises information for use in determining position of a mobile device.

At stage 1012, the method 1000 may include wirelessly receiving, at a first UE from a second UE, a map request that includes a location of the second UE and an indication of a geographic region of interest. For example, the map request may be an explicit request for one or more portions of a map or an implicit request for one or more portions of a map. The map request may be an explicit and/or implicit request for map information from which the first UE may determine whether the location of the second UE, as indicated in the map request, is in the geographic region of interest. For example, the UE 533 may receive the map request message 552 from the UE 532 at stage 618 of the flow 600. The UE 533 may be called a map distributor as the UE 533 has a map from the server 16 that the UE 533 may distribute to the UE 532. The location of the second UE in the map request is an indication of the location of the second UE. The transceiver 1420 (e.g., the wireless receiver 244 of the transceiver 215) and the processor 1410 (and possibly the memory 1430) may comprise means for wirelessly receiving the map request. The UE 532 may send the request in response to the UE 532 determining that the UE 532 (e.g., the memory 1430) does not have a map that includes the geographic region of interest and the location of the UE 531 indicated by the UE 531 in the message sent at stage 614.

At stage 1014, the method 1000 may include selecting at least one path portion of a map that includes a path from the location to an edge of the map, the map spanning a map area that includes the geographic region of interest. Thus, the at least one path portion of the map includes the path from the location to the edge of the map. For example, the UE 533 (e.g., the processor 1410 possibly in conjunction with the memory 1430) may use the indication of the geographic region of interest and the location of the UE 531 conveyed by the UE 532 in the message 552 at stage 618 to find a multi-resolution map provided by the server 16 that includes the geographic region of interest and the location of the UE 531. The map may have been previously provided by the server 16, or the UE 533 may send a request for the map to the server 16 in response to receiving the map request message 552 at stage 618. The UE 533 (e.g., the processor 1410, possibly in conjunction with the memory 1430, of the UE 533) may find the location of the UE 531 in the map, determine a path from the location to an edge of the map, and determine path portions of the map (that may be from different resolution levels of the map) that include the path from the location to the edge of the map. The processor 1410 and possibly the memory 1430 may comprise means for selecting at least one path portion of the map.

At stage 1016, the method 1000 may include wirelessly sending, from the first UE to the second UE, at least one map portion of the map spanning less than the map area and including the at least one path portion of the map. Because the at least one map portion spans less than the map area 802, less than all map data may be transferred from the UE 533 to the UE 532 which may help convey information to the UE 532 for determining whether the UE 531 is in the geographic area of interest 806 within time constraints and bandwidth constraints of a channel between the UE 533 and the UE 532. The at least one map portion includes the at least one path portion so that the at least one map portion covers the path, e.g., the path 874. The processor 1410 (and possibly the memory 1430) and the transceiver 1420 (e.g., the wireless transmitter 242) may comprise means for wirelessly sending the at least map portion.

The method 1000 may include one or more of the following features. The map may comprise a one-way tree comprising a data block level and node levels, the data block level and each of the node levels spanning the map area and each having a different resolution than other levels of the map, each of multiple data blocks of the data block level corresponding to a respective data-block sub-area of the map area, and each node of each of the node levels corresponding to a respective node sub-area of the map area. The method 1000 may include wirelessly sending, from the first UE to the second UE, a root value of the map digitally signed with a digital signature of a trusted source. For example, the UE 533 may send, to the UE 532, the root hash value 860 digitally signed with a digital certificate of the server 16. The UE 533 may receive the digitally signed root hash value along with the hash tree 900 from the server 16. The UE 532 may also or alternatively receive the signed root hash value (or other root value) from other means, e.g., from the server 16 directly or from another UE. The processor 1410 (and possibly the memory 1430) and the transceiver 1420 (e.g., the wireless transmitter 242) may comprise means for wirelessly sending the root value. Each of the data blocks of the data block level may include an indication of whether a respective data-block sub-area of the map includes a portion of a border of the geographic region of interest, and for each crossing of the border of the geographic region of interest, a corresponding path portion includes a respective data block. The UE 533 may select the lowest-resolution portion(s) of the map, i.e., the largest-coverage-area portion(s) of the map, that includes the path but does not include any portion of the border 804. For each crossing, if any, of the path with the border 804 of the geographic area of interest 806, the UE 533 includes a highest-resolution portion of the multi-resolution map that includes a respective portion of the path and a respective portion of the border 804. For example, for the path 874, the UE 533 would select the data block V22132 as including the path 874 and the border 804. The UE may select the at least one map portion to include one or more one-way sub-values of the map that can be used in conjunction with the at least one path portion to determine a root value of the map. If the at least one path portion includes a data block corresponding to a particular lowest-level node, then the UE may include the remainder of the data blocks corresponding to the particular lowest-level node, and the node values for the other nodes (i.e., outside of the branch from the root value to the data block including the path) in each of the node levels from the lowest-level node to the node level just below the root value. For example, as discussed above, with the data blocks V22133, V22132 being part of the at least one path portion, the UE 533 may further select data blocks V22131, V22134 and nodes V2211, V2212, V2214, V222, V223, V224, V21, V23, V24, V1, V3, V4 to be included in the at least one map portion. The one or more one-way sub-values of the map may consist of a minimum number of map portions in addition to the at least one path portion in order to determine the root value. For example, the UE 533 may include only the data blocks V22131, V22134 and nodes V2211, V2212, V2214, V222, V223, V224, V21, V23, V24, V1, V3, V4 in addition to the data blocks V22132, V22133 for the path 874. As another example, for a path 878 from a location 879 (see FIG. 8), the at least one path portion may consist of node V4 only, and the at least one map portion may consist of V1, V2, V3 in addition to V4.

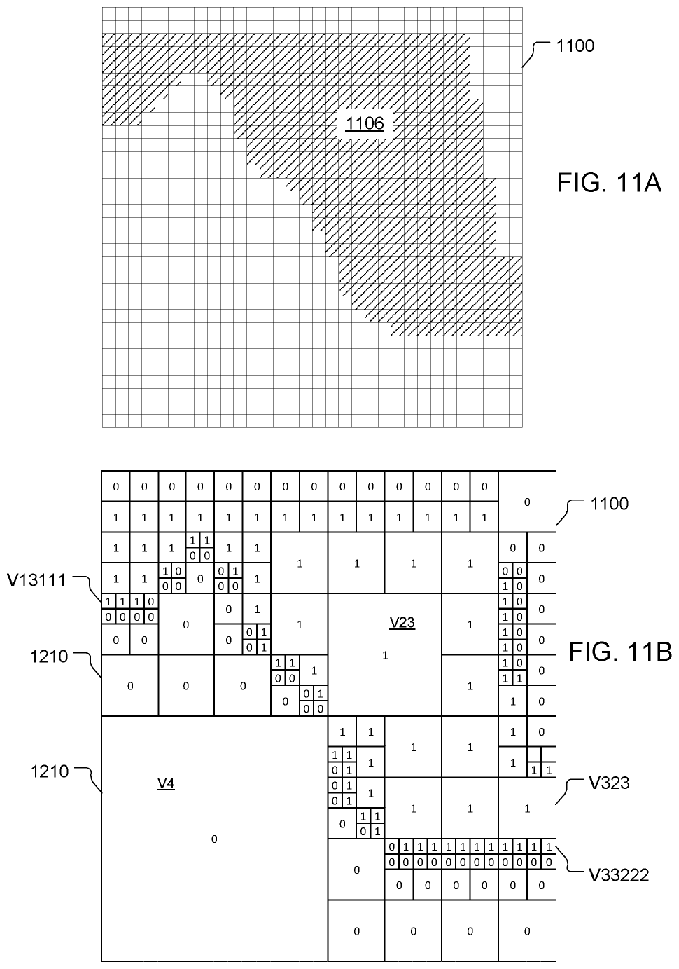

Numerous other configurations and operations are possible. For example, referring to FIG. 11A, with further reference to FIGS. 1-9, a map 1100 may be divided into map components assigned values (e.g., by the server 16) such that each map component value is indicative of a physical relationship of each of sub-area of a map area of the map 1100 relative to a geographic region of interest 1106. For example, a non-zero value of a map component may indicate that the corresponding sub-area of the map 1100 is inside of the geographic region of interest 1106 and a zero value of a map component may indicate that the corresponding sub-area of the map 1100 is outside of the geographic region of interest 1106. These values are examples (e.g., different non-zero values may indicate inside vs. outside of the geographic region of interest 1106, or non-zero values could indicate being outside the geographic region of interest 1106, etc.). The map components include segments and nodes. A segment may be a highest-resolution portion of the map 1100, e.g., a data block as discussed with respect to FIG. 8C, or may be lower-resolution portion of the map 1100 that corresponds to higher-resolution portions of the map that are all either inside the geographic region of interest 1106 or all outside the geographic region of interest 1106. For the example shown in FIG. 8C, the respective value of each data block 812 is also indicative of the relationship of the respective sub-area to the geographic region of interest, in that case, whether the respective data block 812 includes a portion of the border 804 or not. The segment values of lower-resolution segments may or may not be a function of the corresponding higher-resolution segments. For example, a segment value of a lower-resolution segment may be a function (e.g., a one-way function) of the segment values of the corresponding higher-resolution segments, or may be independent of such values. For example, a highest-resolution segment inside the geographic region of interest 1106 may be assigned a value of 1, and a segment value of a lower-resolution segment inside the geographic region of interest 1106 may also be assigned a value of 1, or may be a function of multiple higher-resolution segment values each with a value of 1 (or themselves a function of a group of values of still higher-resolution segments). Lower-resolution segments with corresponding higher-resolution segments all having values of 0 will typically be assigned segment values of 0. These values are examples for illustration purposes only and not limiting of the invention. For example, lower-resolution segments (e.g., segments not at the highest-resolution possible according to a protocol implemented by the server 16) may be assigned any of a variety of values, such as values other than 1, or multi-bit values of 1 (e.g., 0001), etc. Each node value is a function of a combination of values of map components of a next-higher-resolution relative to the node. Each node value is thus a function of a combination of node values, or a combination of segment values, or a combination of one or more segment values and one or more node values.

Referring also to FIG. 11B, the server 16 may divide the map 1100 into segments 1210 and assign a segment value to each segment that indicates the relationship of the sub-area of the respective segment to the geographic region of interest 1106. In this example, the server 16 is configured to assign a non-zero value to each segment that is within the geographic region of interest 1106 and to assign a value of zero to each segment that is outside of the geographic region of interest. In the example shown, the map 1100 is divided in accordance with a protocol that is the same as the protocol used to pixelate the map 800 and to produce the hash tree 900. That is, the map 1100 is divided into quarters, that are each divided into quarters, etc., until the highest-resolution of the dividing is reached. Stated differently, the map 1100 is divided into a highest-resolution level of pixels, and the pixels are grouped for each successively lower-resolution level. This protocol is but one example, and not limiting of the invention. Other protocols may be used to divide the map 1100, e.g., a spiral progression (e.g., moving around the map 1100 in a spiral fashion to select map components to correspond to nodes), random selection of map components to correspond to a node, etc. The grouping into lower levels of resolution (or division of levels into higher-resolution levels) may be done in any number of different ways and need not be based on location in the map 1100 (i.e., a lower-resolution node need not span the higher-resolution portions used to produce the lower-resolution node value).

As shown in FIG. 11B, the segments 1210 span different sizes of sub-areas of the map 1100. The server 16 may be configured to store segment values for a one-way tree for less than all (and possibly none) of the highest-resolution segments if there are lower-resolution sub-areas with corresponding higher-resolution sub-areas that are all either inside or outside the geographic region of interest 1106. The server 16 may be configured to store segment values for only the lowest-resolution segments 1210 that are completely inside or completely outside the geographic region of interest 1106. This may help reduce memory use and complexity of a multi-resolution map (of segment values and node values) corresponding to the map 1100, e.g., enabling less complex, and thus faster and less-power consuming, determinations of map portions to be sent by one UE to another UE. For example, the server 16 may be configured to store the lowest-resolution segment value possible for each portion of the map 1100 in accordance with a protocol for dividing the map and producing nodes, in view of the particular shape of the geographic region of interest 1106. Typically, values for the highest-resolution segments according to the protocol adjacent to the border between being inside and outside the geographic region of interest 1106 will be stored in the memory 411 and provided to other entities, e.g., one or more of the UEs 531-534. In the example shown in FIG. 11B, the server 16 may store only the value V4 for the entire third quadrant of the map 1100 (i.e., without storing V41, V42, etc.), store the value V23 for the third quadrant within the second quadrant of the map 1100, store the value V323 for the third quadrant within the second quadrant within the third quadrant of the map 1100, and store highest-resolution values V13111 and V33222 at edge portions of the region of interest 1106.

The server 16 may be configured to store only segment values for lower-resolution segments, if possible, for other map division techniques, e.g., where map components indicate whether the respective sub-area includes a portion of a border of the geographic region of interest. For example, the server 16 may not store values for the individual data blocks 812 corresponding to the node with value V2214 shown in FIG. 9, but only store the value V2214 (which may or may not be a function of the data block values), or even a higher-level segment value if the data blocks for the values V2211, V2212, V2213 were also all 1's. In such a case, the UE 532 providing map portions (of a multi-resolution map, e.g., values of a one-way tree) may provide lower-resolution map components as part of a path from a location of a UE to an edge of the map as appropriate.

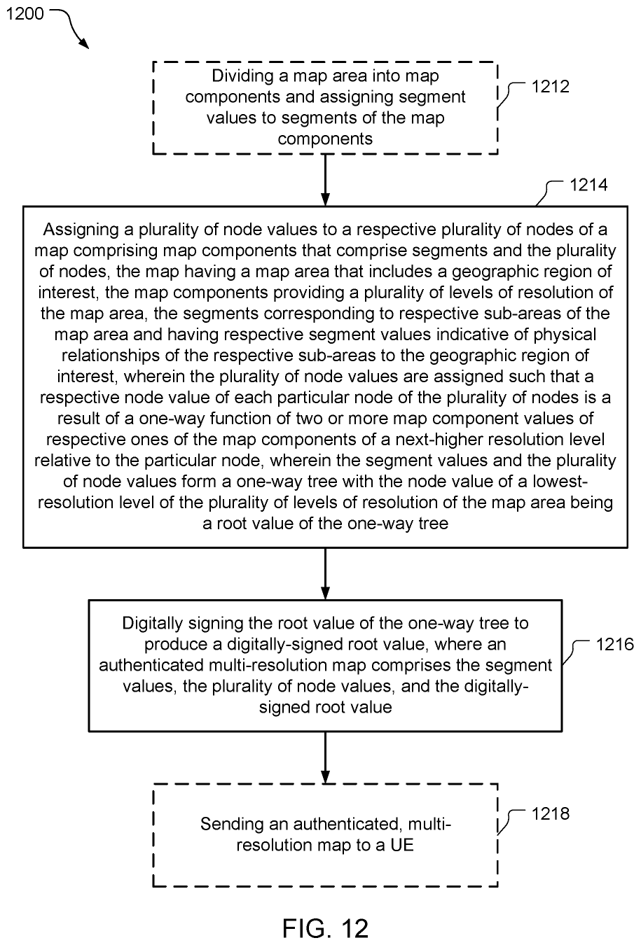

Referring to FIG. 12, with further reference to FIGS. 1-11, a method 1200 of providing an authenticated multi-resolution map includes the stages shown. The method 1200 is, however, an example only and not limiting. The method 1200 may be altered, e.g., by having stages added, removed, rearranged, combined, performed concurrently, and/or having single stages split into multiple stages. For example, the stage 1212 and/or the stage 1218 may be omitted, e.g., if a pixelated map is provided or if a UE determines the authenticated multi-resolution map. Optional stage 1212, and stages 1214, 1216 may be included in stage 610 shown in FIG. 6. The stage 1212 may be included as part of stage 1214.

At stage 1212, the method 1200 may include dividing a map area into map components and assigning segment values to segments of the map components. For example, the server 16 (or another entity such as a UE) may divide the map 1100 into map components, e.g., segments and nodes of various resolution levels, according to a protocol for dividing the map. The segments in combination may span the map area even though different segments may be at different levels of resolution. According to the protocol, the server 16 may divide the map 1100 in any of a variety of ways, e.g., into square pixels, grouping lower-level (higher-resolution) map components (e.g., grouping abutting highest-level segments) into higher-level (lower-resolution) map components (e.g., segments or nodes) that overlap the lower-level map components completely, or grouping lower-level map components into higher-level map components that only partially overlap the lower-level map components or that do not overlap the lower-level map components at all, or combinations of these (e.g., with different levels grouped in different ways or some levels having one or more map components not overlapping corresponding lower-level map components and some levels having one or more map components overlapping (partially or completely) the corresponding lower-level map components. The server 16 may assign segment values to the segments of the map components to indicate a physical relationship of each segment to the geographic region of interest. For example, a segment value may indicate whether the respective sub-area of the map is inside or outside of the geographic region of interest, or whether the respective sub-area includes a portion of a border of the geographic region of interest. For example, a non-zero segment value may indicate that the respective sub-area of the map is inside the geographic region of interest, or that the respective sub-area includes a portion of a border of the geographic region of interest. The server 16 may assign segment values to the coarsest-granularity sub-areas of the map, as determined by the protocol, that do not include sub-areas both inside and outside a region of interest (i.e., that are completely inside or completely outside the region of interest) or that do not include a portion of the border of the geographic region of interest. The map area may be divided in accordance with a protocol of segment size and segment arrangement such that the respective sub-area of each segment having a respective segment value of zero is as large as possible in accordance with the protocol of segment size and segment arrangement without the respective sub-area including any portion of the border of the geographic region of interest The processor 410 and the memory 411 may comprise means for dividing the map area and means for assigning the segment values. Also or alternatively, the processor 1410 and the memory 1430 may comprise means for dividing the map area and means for assigning the segment values.

At stage 1214, the method 1200 may include assigning a plurality of node values to a respective plurality of nodes of a map comprising map components that comprise segments and the plurality of nodes, the map having a map area that includes a geographic region of interest, the map components providing a plurality of levels of resolution of the map area, the segments corresponding to respective sub-areas of the map area and having respective segment values indicative of physical relationships of the respective sub-areas to the geographic region of interest, wherein the plurality of node values are assigned such that a respective node value of each particular node of the plurality of nodes is a result of a one-way function of two or more map component values of respective ones of the map components of a next-higher resolution level relative to the particular node, wherein the segment values and the plurality of node values form a one-way tree with the node value of a lowest-resolution level of the plurality of levels of resolution of the map area being a root value of the one-way tree. For example, the server 16 may assign node values by using the values of a group of lower-level map components, grouped in accordance with the protocol for dividing the map area, as inputs to a one-way function the results of which (i.e., for each grouping) is the respective node value. The lower-level map components for any particular node may be two or more segments, two or more nodes, or one or more segments and one or more nodes. The processor 410 and the memory 411 may comprise means for assigning the plurality of node values to the plurality of nodes. Also or alternatively, the processor 1410 and the memory 1430 may comprise means for assigning the plurality of node values to the plurality of nodes.

At stage 1216, the method 1200 may include digitally signing the root value of the one-way tree to produce a digitally-signed root value, wherein the authenticated multi-resolution map comprises the segment values, the plurality of node values, and the digitally-signed root value. For example, the server 16 (e.g., the processor 410 (possibly in combination with the memory 411)) digitally signs the value of the one-way tree and thus may comprise means for digitally signing the root value. Also or alternatively, the processor 1410 and the memory 1430 may comprise means for digitally signing the root value.

At stage 1218, the method 1200 may include sending the authenticated multi-resolution map to a UE. For example, the server 16 may send the authenticated multi-resolution map to one or more of the UEs 531-534 via the transceiver 415 (e.g., the wired transmitter 452 and/or the wireless transmitter 442 and the antenna 446), e.g., to the UE 533 as shown at stage 612 of FIG. 6. The processor 410, the memory 411, the transceiver 415 (e.g., the transmitter 442 and/or the transmitter 452), and possibly the antenna 446 may comprise means for sending the authenticated multi-resolution map to a UE. Also or alternatively, the processor 1410, the memory 1430, and the transceiver 1420 may comprise means for sending the authenticated multi-resolution map to a UE.

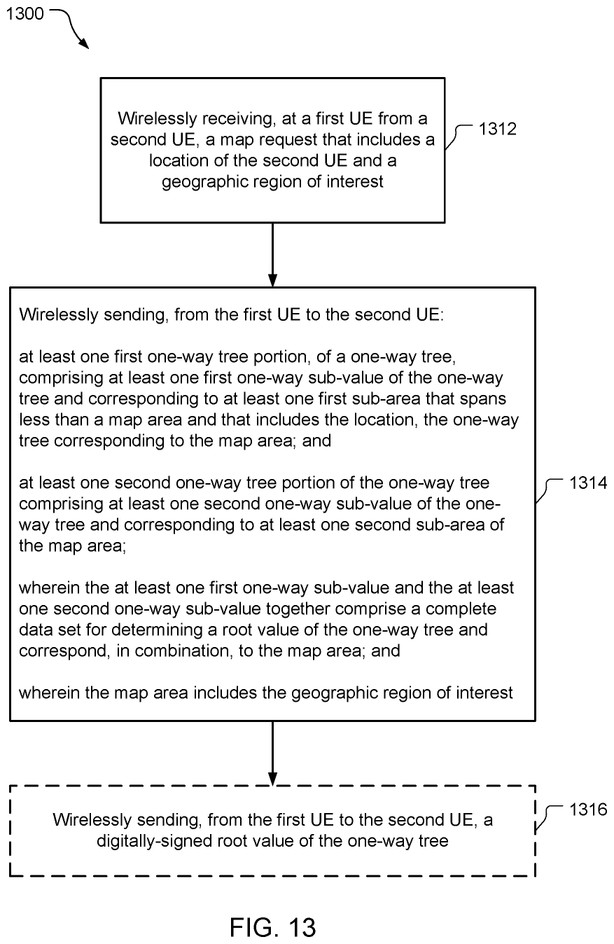

Referring to FIG. 13, with further reference to FIGS. 1-12, a method 1300 of providing positioning information includes the stages shown. The method 1300 is, however, an example only and not limiting. The method 1300 may be altered, e.g., by having stages added, removed, rearranged, combined, performed concurrently, and/or having single stages split into multiple stages. Positioning information comprises information for use in determining position of a mobile device.

At stage 1312, the method 1300 may include wirelessly receiving, at a first UE from a second UE, a map request that includes a location of the second UE and an indication of a geographic region of interest. Stage 1312 may be similar to, or the same as, stage 1012 discussed above with respect to FIG. 10. The location is an indication of the location and the geographic region of interest is an indication of the geographic region of interest as neither the location itself nor the region of interest itself can be sent as part of a message.

At stage 1314, the method 1300 may include wirelessly sending, from the first UE to the second UE: at least one first one-way tree portion, of a one-way tree, comprising at least one first one-way sub-value of the one-way tree and corresponding to at least one first sub-area that spans less than a map area and that includes the location, the one-way tree corresponding to the map area; and at least one second one-way tree portion of the one-way tree comprising at least one second one-way sub-value of the one-way tree and corresponding to at least one second sub-area of the map area; where the at least one first one-way sub-value and the at least one second one-way sub-value together comprise a complete data set for determining a root value of the one-way tree and correspond, in combination, to the map area; and where the map area includes the geographic region of interest. For example, the UE 533 may, in response to receiving the map request, determine a segment of the map that includes the location, and determine (e.g., calculate or select) the segment value for this segment, and the value of one or more other map components in order to complete the one-way tree such that the root value of the one-way tree may be determined, and send the segment value and the value(s) of the one or more other map component(s) to the UE 532. The at least one first one-way tree portion may be the segment and other component(s) that make up a path from the location to an edge of the map if the map component values indicate whether the respective sub-areas include a portion of the border of the geographic region of interest. The at least one first one-way tree portion may consist of a single one-way tree portion, e.g., a single segment, e.g., if the map component values indicate whether the respective sub-areas are inside or outside of the geographic region of interest. For example, a non-zero value (no matter how assigned or determined, e.g., selected or calculated using a one-way function) may indicate that the sub-area is inside the geographic region of interest. The non-zero value may be, for example, the result of a one-way function applied to values of sub-levels, or a one, or field of ones at the coarsest resolution possible. The at least one second one-way tree portion may correspond to all of the map area other than the at least one first sub-area. For example, referring to FIG. 12, if the location is in the sub-area corresponding to the segment value V23, then the at least one second one-way tree portion may comprise the values of the other map components corresponding to the same node at the next-higher level as the value V23, here the values V21, V22, V24 corresponding to the node V2, and the values of the other map components at that next-higher level, here the values V1, V3, V4. These values would thus span the entire map area, and would provide enough information to derive the root value of the one-way tree. The processor 1410, the memory 1430, and the transceiver 1420 may comprise means for wirelessly sending the at least one first one-way tree portion and the at least one second one-way tree portion.

At stage 1316, the method 1300 may include wirelessly sending, from the first UE to the second UE, a digitally-signed root value of the one-way tree. For example, the UE 533 may send, via the transceiver 1420 (e.g., the wireless transmitter 242, and the antenna 246), the root value of the one-way tree, digitally signed with a digital signature (e.g., of the server 16). The processor 1410, the transceiver 1420, and the antenna 246 may comprise means for wirelessly sending the digitally-signed root value.

The method 1300 may include one or more of the following features. For example, the at least one first sub-area may include a path from the location to an edge of the map area and for each crossing of a border of the geographic region of interest by the path, a corresponding one of the at least one first one-way tree portion is of a highest resolution of the one-way tree. As another example, each of the at least one first one-way tree portion that indicates that the respective first sub-area lacks any portion of the border of the geographic region of interest may be of a lowest resolution possible, of the one-way tree, while the respective first sub-area includes a corresponding portion of the path and lacks any portion of the border of the geographic region of interest. Thus, for example, portions of the one-way tree corresponding to areas either outside or inside the region of interest 806, and displaced from the border 804, may correspond to as much of the map area as possible, in accordance with the protocol for dividing the map area, which may decrease complexity of the one-way tree and reduce processing power and time used to verify location of a UE in the region of interest 806. The at least one second one-way tree portion consists of a minimum number of one or more one-way tree portions in addition to the at least one first one-way tree portion in order to enable determination of the root value of the one-way tree. For example, the processor 410 and/or the processor 1410 may determine and store as few map component values as possible in accordance with a protocol for dividing the map in order to be able to determine the root value of the one-way tree.

### Other Considerations

Having described several example configurations, other examples or implementations including various modifications, alternative constructions, and equivalents may be used. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations. A statement that a feature implements, or a statement that a feature may implement, a function includes that the feature may be configured to implement the function (e.g., a statement that an item performs, or a statement that the item may perform, function X includes that the item may be configured to perform function X). Elements discussed may be components of a larger system, wherein other rules may take precedence over or otherwise modify the application of the invention. Also, a number of operations may be undertaken before, during, or after above-discussed elements or operations are considered. As another example, discussed elements may be components of a larger system, wherein other rules may take precedence over or otherwise modify the application of the invention. Also, a number of operations may be undertaken before, during, or after the above elements are considered. Accordingly, the above description does not bound the scope of the claims.

Also, as used herein, “or” as used in a list of items prefaced by “at least one of” or prefaced by “one or more of” indicates a disjunctive list such that, for example, a list of “at least one of A, B, or C,” or a list of “one or more of A, B, or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B means that the item may be configured to perform the function regarding A, or may be configured to perform the function regarding B, or may be configured to perform the function regarding A and B. For example, a phrase of “a processor configured to measure at least one of A or B” means that the processor may be configured to measure A (and may or may not be configured to measure B), or may be configured to measure B (and may or may not be configured to measure A), or may be configured to measure A and B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation of a processor configured to at least one of A or B means that the processor is configured to A (and may or may not be configured to B) or is configured to B (and may or may not be configured to B) or is configured to A and B, where A is a function (e.g., determine, obtain, or measure, etc.) and B is a function.

As used herein, the singular forms “a,” “an,” and “the” include the plural forms as well, unless the context clearly indicates otherwise. For example, “a processor” may include one processor or multiple processors. The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

As used herein, unless otherwise stated, a statement that a function or operation is “based on” an item or condition means that the function or operation is based on the stated item or condition and may be based on one or more items and/or conditions in addition to the stated item or condition.

Further, an indication that information is sent or transmitted, or a statement of sending or transmitting information, “to” an entity does not require completion of the communication. Such indications or statements include situations where the information is conveyed from a sending entity but does not reach an intended recipient of the information. The intended recipient, even if not actually receiving the information, may still be referred to as a receiving entity, e.g., a receiving execution environment. Further, an entity that is configured to send or transmit information “to” an intended recipient is not required to be configured to complete the delivery of the information to the intended recipient. For example, the entity may provide the information, with an indication of the intended recipient, to another entity that is capable of forwarding the information along with an indication of the intended recipient.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection. A wireless communication network may not have all communications transmitted wirelessly, but is configured to have at least some communications transmitted wirelessly. Further, the term “wireless communication device,” or similar term, does not require that the functionality of the device is exclusively, or evenly primarily, for communication, or that the device be a mobile device, but indicates that the device includes wireless communication capability (one-way or two-way), e.g., includes at least one radio (each radio being part of a transmitter, receiver, or transceiver) for wireless communication.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the scope of the disclosure.

The terms “processor-readable medium,” “machine-readable medium,” and “computer-readable medium,” as used herein, refer to any medium that participates in providing data that causes a machine to operate in a specific fashion. Using a computing platform, various computer-readable media might be involved in providing instructions/code to processor(s) for execution and/or might be used to store and/or carry such instructions/code (e.g., as signals). In many implementations, a computer-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Components, functional or otherwise, shown in the figures and/or discussed herein as being connected or communicating with each other are communicatively coupled unless otherwise noted. That is, they may be directly or indirectly connected to enable communication between them.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. A method of providing positioning information, the method comprising:
wirelessly receiving, at a first user equipment (UE) from a second UE, a map request that includes a location and a geographic region of interest; and
wirelessly sending, from the first UE to the second UE:
at least one first one-way tree portion, of a one-way tree, comprising at least one first one-way sub-value of the one-way tree and corresponding to at least one first sub-area that spans less than a map area and that includes the location, the one-way tree corresponding to the map area; and
at least one second one-way tree portion of the one-way tree comprising at least one second one-way sub-value of the one-way tree and corresponding to at least one second sub-area of the map area;
wherein the at least one first one-way sub-value and the at least one second one-way sub-value together comprise a complete data set for determining a root value of the one-way tree and correspond, in combination, to the map area; and
wherein the map area includes the geographic region of interest.

2. The method of claim 1, wherein the at least one first one-way tree portion consists of a single first one-way tree portion that corresponds to a single first sub-area that includes the location, the single first one-way tree portion including an indication of whether the single first sub-area is within the geographic region of interest.

3. The method of claim 1, wherein the at least one first sub-area includes a path from the location to an edge of the map area.

4. The method of claim 3, wherein for each crossing of a border of the geographic region of interest by the path, a corresponding one of the at least one first one-way tree portion is of a highest resolution of the one-way tree.

5. The method of claim 4, wherein each of the at least one first one-way tree portion that indicates that the respective first sub-area lacks any portion of the border of the geographic region of interest is of a lowest resolution possible, of the one-way tree, while the respective first sub-area includes a corresponding portion of the path and lacks any portion of the border of the geographic region of interest.

6. The method of claim 1, wherein the at least one second one-way tree portion consists of a minimum number of one or more one-way tree portions in addition to the at least one first one-way tree portion in order to enable determination of the root value of the one-way tree.

7. A user equipment (UE) comprising:
a transceiver configured to wirelessly receive and transmit signals;
a memory storing a map; and
a processor, communicatively coupled to the transceiver and the memory, configured to respond to receiving, via the transceiver, a map request that includes a location and a geographic region of interest by determining and sending, via the transceiver:
at least one first one-way tree portion, of a one-way tree, comprising at least one first one-way sub-value of the one-way tree and corresponding to at least one first sub-area that spans less than a map area and that includes the location, the one-way tree corresponding to the map area; and
at least one second one-way tree portion of the one-way tree comprising at least one second one-way sub-value of the one-way tree and corresponding to at least one second sub-area of the map area;
wherein the at least one first one-way sub-value and the at least one second one-way sub-value together comprise a complete data set for determining a root value of the one-way tree and correspond, in combination, to the map area; and
wherein the map area includes the geographic region of interest.

8. The UE of claim 7, wherein the at least one first one-way tree portion consists of a single first one-way tree portion that corresponds to a single first sub-area that includes the location, the single first one-way tree portion including an indication of whether the single first sub-area is within the geographic region of interest.

9. The UE of claim 7, wherein the at least one second sub-area corresponds to the all of map area other than the at least one first sub-area.

10. The UE of claim 7, wherein the processor is configured to send, via the transceiver, the root value, of the one-way tree, digitally signed with a digital signature.

11. The UE of claim 7, wherein the at least one first sub-area includes a path from the location to an edge of the map area.

12. The UE of claim 11, wherein for each crossing of a border of the geographic region of interest by the path, a corresponding one of the at least one first one-way tree portion is of a highest resolution of the one-way tree.

13. The UE of claim 12, wherein each of the at least one first one-way tree portion that indicates that the respective first sub-area lacks any portion of the border of the geographic region of interest is of a lowest resolution possible, of the one-way tree, while the respective first sub-area includes a corresponding portion of the path and lacks any portion of the border of the geographic region of interest.

14. The UE of claim 7, wherein the at least one second one-way tree portion consists of a minimum number of one or more one-way tree portions in addition to the at least one first one-way tree portion in order to enable determination of the root value of the one-way tree.

15. A first user equipment (UE) comprising:
first means for wirelessly receiving, from a second UE, a map request that includes a location and a geographic region of interest;
second means for determining and wirelessly sending, to the second UE:
at least one first one-way tree portion, of a one-way tree, comprising at least one first one-way sub-value of the one-way tree and corresponding to at least one first sub-area that spans less than a map area and that includes the location, the one-way tree corresponding to the map area; and
at least one second one-way tree portion of the one-way tree comprising at least one second one-way sub-value of the one-way tree and corresponding to at least one second sub-area of the map area;
wherein the at least one first one-way sub-value and the at least one second one-way sub-value together comprise a complete data set for determining a root value of the one-way tree and correspond, in combination, to the map area; and
wherein the map area includes the geographic region of interest.

16. The first UE of claim 15, wherein the at least one first one-way tree portion consists of a single first one-way tree portion that corresponds to a single first sub-area that includes the location, the single first one-way tree portion including an indication of whether the single first sub-area is within the geographic region of interest.

17. The first UE of claim 15, wherein the at least one second sub-area corresponds to all of the map area other than the at least one first sub-area.

18. The first UE of claim 15, wherein the second means are further for determining and wirelessly sending, to the second UE, the root value, of the one-way tree, digitally signed with a digital signature.

19. The first UE of claim 15, wherein the at least one first sub-area includes a path from the location to an edge of the map area.

20. The first UE of claim 19, wherein for each crossing of a border of the geographic region of interest by the path, a corresponding one of the at least one first one-way tree portion is of a highest resolution of the one-way tree.

21. The first UE of claim 20, wherein each of the at least one first one-way tree portion that indicates that the respective first sub-area lacks any portion of the border of the geographic region of interest is of a lowest resolution possible, of the one-way tree, while the respective first sub-area includes a corresponding portion of the path and lacks any portion of the border of the geographic region of interest.

22. The first UE of claim 15, wherein the at least one second one-way tree portion consists of a minimum number of one or more one-way tree portions in addition to the at least one first one-way tree portion in order to enable determination of the root value of the one-way tree.

23. A non-transitory, processor-readable storage medium comprising processor-readable instructions configured to cause a processor, in order to provide positioning information, to:
respond to receiving, via a transceiver, a map request that includes a location and a geographic region of interest by determining and sending, via the transceiver:
at least one first one-way tree portion, of a one-way tree, comprising at least one first one-way sub-value of the one-way tree and corresponding to at least one first sub-area that spans less than a map area and that includes the location, the one-way tree corresponding to the map area; and
at least one second one-way tree portion of the one-way tree comprising at least one second one-way sub-value of the one-way tree and corresponding to at least one second sub-area of the map area;
wherein the at least one first one-way sub-value and the at least one second one-way sub-value together comprise a complete data set for determining a root value of the one-way tree and correspond, in combination, to the map area; and
wherein the map area includes the geographic region of interest.

24. The storage medium of claim 23, wherein the at least one first one-way tree portion consists of a single first one-way tree portion that corresponds to a single first sub-area that includes the location, the single first one-way tree portion including an indication of whether the single first sub-area is within the geographic region of interest.

25. The storage medium of claim 23, wherein the at least one second sub-area corresponds to the all of map area other than the at least one first sub-area.

26. The storage medium of claim 23, wherein the instructions are configured to cause the processor to send, via the transceiver, the root value, of the one-way tree, digitally signed with a digital signature.

27. The storage medium of claim 23, wherein the at least one first sub-area includes a path from the location to an edge of the map area.

28. The storage medium of claim 27, wherein for each crossing of a border of the geographic region of interest by the path, a corresponding one of the at least one first one-way tree portion is of a highest resolution of the one-way tree.

29. The storage medium of claim 28, wherein each of the at least one first one-way tree portion that indicates that the respective first sub-area lacks any portion of the border of the geographic region of interest is of a lowest resolution possible, of the one-way tree, while the respective first sub-area includes a corresponding portion of the path and lacks any portion of the border of the geographic region of interest.

30. The storage medium of claim 23, wherein the at least one second one-way tree portion consists of a minimum number of one or more one-way tree portions in addition to the at least one first one-way tree portion in order to enable determination of the root value of the one-way tree.
